(19) United States
(12) Patent Application Publication
(10) Pub. No.: US 2026/0320848 A1
(43) Pub. Date: Oct. 15, 2026

(54) CODING METHOD AND APPARATUS, DECODING METHOD AND APPARATUS, CODER, DECODER, BITSTREAM, AND STORAGE MEDIUM

(71) Applicant: GUANGDONG OPPO MOBILE TELECOMMUNICATIONS CORP., LTD., Dongguan (CN)

(72) Inventors: Hui YUAN, Dongguan (CN); Tian GUO, Dongguan (CN); Chen CHEN, Dongguan (CN); Xiaolong MAO, Dongguan (CN)

(73) Assignee: GUANGDONG OPPO MOBILE TELECOMMUNICATIONS CORP., LTD., Dongguan (CN)

(21) Appl. No.: 19/710,931

(22) Filed: Jun. 17, 2026

Related U.S. Application Data
(63) Continuation of application No. PCT/CN2023/142973, filed on Dec. 28, 2023.

(51) Int. Cl. G06T 9/40; G06T 7/60

(52) U.S. Cl. CPC G06T 9/40; G06T 7/60; G06T 2200/04; G06T 2207/10028

(57) ABSTRACT

Provided in the present application are a coding method and apparatus, a decoding method and apparatus, a point cloud coder, a point cloud decoder, a bitstream, and a storage medium. The decoding method comprises: on the basis of geometric information of a current point cloud, determining a reference point of a current point in the current point cloud, wherein the reference point includes a time-domain reference point that is one or more points in a reference point cloud, and the reference point cloud is point cloud data that has been decoded before the current point cloud is decoded; based on a weighted prediction parameter, processing an attribute value of the time-domain reference point, to obtain a time-domain reference attribute value, wherein the weighted prediction parameter is obtained by decoding a bitstream; and based on the time-domain reference attribute value, determining an attribute reconstruction value of the current point.

### CROSS-REFERENCE TO RELATED APPLICATIONS

This application is a continuation of International Application No. PCT/CN2023/142973, filed on Dec. 28, 2023, the disclosure of which is hereby incorporated by reference in its entirety.

### TECHNICAL FIELD

Embodiments of this application relate to point cloud encoding and decoding technologies, and relate to, but are not limited to, an encoding method and apparatus, a decoding method and apparatus, a point cloud encoder, a point cloud decoder, a bit stream, and a storage medium.

### BACKGROUND

A point cloud is a set of discrete points in space that are irregularly distributed and represent a spatial structure and surface attributes of a three-dimensional object or scene. Point cloud data typically includes geometric information and attribute information of sampling points, where the geometric information includes three-dimensional position information of the sampling points, and the attribute information includes color information and/or reflectance information of the sampling points.

A point cloud may flexibly and conveniently express a spatial structure and a surface attribute of a three-dimensional object or scene. Since the point cloud is obtained by directly performing sampling on a real object, an extremely strong sense of reality can be provided on a premise of ensuring precision. Therefore, the point cloud is widely applied in virtual reality gaming, computer-aided design, a geographic information system, an automatic navigation system, a digital cultural legacy, free viewpoint broadcasting, three-dimensional immersive remote presentation, three-dimensional reconstruction of a biological organ, and the like.

With the growth of application demands, the processing of massive three-dimensional (3D) point cloud data is constrained by bottlenecks in storage space and transmission bandwidth. To better implement data management, save server storage space, and reduce transmission traffic and transmission time between servers and clients, attribute encoding and decoding of point clouds have become key issues in promoting development of the point cloud industry.

### SUMMARY

An encoding method and apparatus, a decoding method and apparatus, a point cloud encoder, a point cloud decoder, a bit stream, and a storage medium provided in embodiments of this application are implemented as follows:

According to a first aspect of embodiments of this application, a decoding method is provided. The method is applied to a point cloud decoder, and the method includes: determining, based on geometric information of a current point cloud, a reference point of a current point in the current point cloud, where the reference point includes a time-domain reference point, the time-domain reference point is one or more points in a reference point cloud, and the reference point cloud is point cloud data that has been decoded before decoding the current point cloud; processing an attribute value of the time-domain reference point based on a weighted prediction parameter, to obtain a time-domain reference attribute value, where the weighted prediction parameter is obtained by decoding a bit stream; and determining a reconstructed attribute value of the current point based on the time-domain reference attribute value of the time-domain reference point.

According to a second aspect of the embodiments of this application, an encoding method is provided. The method is applied to a point cloud encoder, and the method includes: determining, based on geometric information of a current point cloud, a reference point of a current point in the current point cloud, where the reference point includes a time-domain reference point, the time-domain reference point is one or more points in a reference point cloud, and the reference point cloud is point cloud data that has been encoded before encoding the current point cloud; obtaining a weighted prediction parameter, where the weighted prediction parameter is determined based on attribute values of at least part of points in the current point cloud and reconstructed attribute values of at least part of points in the reference point cloud; processing an attribute value of the time-domain reference point based on the weighted prediction parameter, to obtain a time-domain reference attribute value; and determining an attribute residual value of the current point based on the time-domain reference attribute value of the time-domain reference point.

According to a third aspect of embodiments of this application, a decoding apparatus is provided, applied to a point cloud decoder. The apparatus includes: a first determining module, configured to determine, based on geometric information of a current point cloud, a reference point of a current point in the current point cloud, where the reference point includes a time-domain reference point, the time-domain reference point is one or more points in a reference point cloud, and the reference point cloud is point cloud data that has been decoded before decoding the current point cloud; a first processing module, configured to process an attribute value of the time-domain reference point based on a weighted prediction parameter, to obtain a time-domain reference attribute value, where the weighted prediction parameter is obtained by decoding a bit stream; and a second determining module, configured to determine a reconstructed attribute value of the current point based on the time-domain reference attribute value of the time-domain reference point.

According to a fourth aspect of embodiments of this application, a point cloud decoder is provided. The point cloud decoder includes a first memory and a first processor; where the first memory is configured to store a computer program executable on the first processor; the first processor is configured to, when running the computer program, execute the decoding method according to the first aspect.

According to a fifth aspect of embodiments of this application, an encoding apparatus is provided, applied to a point cloud encoder. The apparatus includes: a third determining module, configured to determine, based on geometric information of a current point cloud, a reference point of a current point in the current point cloud, where the reference point includes a time-domain reference point, the time-domain reference point is one or more points in a reference point cloud, and the reference point cloud is point cloud data that has been decoded before decoding the current point cloud; an obtaining module, configured to obtain a weighted prediction parameter, where the weighted prediction parameter is determined based on attribute values of at least part of points in the current point cloud and reconstructed attribute values of at least part of points in the reference point cloud; a second processing module, configured to process an attribute value of the time-domain reference point based on the weighted prediction parameter, to obtain a time-domain reference attribute value; and a fourth determining module, configured to determine an attribute residual value of the current point based on the time-domain reference attribute value of the time-domain reference point.

According to a sixth aspect of embodiments of this application, a point cloud encoder is provided. The point cloud encoder includes a second memory and a second processor; where the second memory is configured to store a computer program executable on the second processor; the second processor is configured to, when running the computer program, execute the encoding method according to the second aspect.

According to a seventh aspect of embodiments of this application, a bit stream is provided. The bit stream is obtained by using the encoding method according to the second aspect.

According to an eighth aspect of embodiments of this application, an electronic device is provided. The electronic device includes a processor adapted to execute a computer program; and a computer-readable storage medium, where the computer-readable storage medium stores a computer program, and the computer program, when executed by the processor, implements the decoding method according to the first aspect, or when executed by the processor, implements the encoding method according to the second aspect.

According to a ninth aspect of embodiments of this application, a computer-readable storage medium is provided, where the computer-readable storage medium stores a computer program, and the computer program, when executed, implements the decoding method according to the first aspect, or implements the encoding method according to the second aspect.

It should be understood that the foregoing general description and the following detailed description are merely illustrative and explanative, and are not intended to limit this application.

### BRIEF DESCRIPTION OF DRAWINGS

The accompanying drawings herein, which are incorporated into and form a part of the description, illustrate the embodiments in line with this application and are used in conjunction with the description to explain technical solutions of this application. Apparently, the drawings in the following description are merely some embodiments of this application. A person of ordinary skill in the art may still derive other drawings from these drawings without creative efforts.

The flowcharts shown in the drawings are illustrative only and do not necessarily include all content and operations/steps, nor must they be performed in the described order. For example, some operations/steps may be decomposed, while some operations/steps may be combined or partially combined. Therefore, actual execution order may change depending on actual situations.

FIG. 1 is a schematic structural diagram of a point cloud encoder 1 in an MPEG G-PCC attribute encoding and decoding framework.

FIG. 2 is a schematic structural diagram of a point cloud decoder 2 in an MPEG G-PCC attribute encoding and decoding framework.

FIG. 3 is a schematic diagram of an implementation process of PT encoding of point cloud attribute information.

FIG. 4 is a schematic diagram 1 of a process of constructing LODs of a point cloud.

FIG. 5 is a schematic diagram of an implementation process of LT encoding of point cloud attribute information.

FIG. 6 is a schematic diagram of an implementation process of an encoding method according to an embodiment of this application.

FIG. 7 is a schematic diagram 2 of a process of constructing LODs of a point cloud.

FIG. 8 is a schematic diagram of an implementation process of a method for determining an attribute residual value of a current point, according to an embodiment of this application.

FIG. 9 is a schematic diagram of an implementation process of a decoding method according to an embodiment of this application.

FIG. 10 is a schematic diagram of an implementation process of a method for determining a reconstructed attribute value of a current point, according to an embodiment of this application.

FIG. 11 is a schematic diagram of an implementation process of updating a reconstructed attribute value of a point in at least one first refinement level, according to an embodiment of this application.

FIG. 12 is a schematic diagram of an implementation process of a core method according to an embodiment of this application.

FIG. 13 is a schematic diagram of test results of an encoding and decoding method under a condition C1 according to an embodiment of this application.

FIG. 14 is a schematic diagram of test results of an encoding and decoding method under a condition C2 according to an embodiment of this application.

FIG. 15 is a schematic diagram of test results of an encoding and decoding method under a condition CW according to an embodiment of this application.

FIG. 16 is a schematic diagram of test results of an encoding and decoding method under a condition CY according to an embodiment of this application.

FIG. 17 is a schematic structural diagram of a decoding apparatus according to an embodiment of this application.

FIG. 18 is a schematic structural diagram of an encoding apparatus according to an embodiment of this application.

FIG. 19 is a schematic structural diagram of a point cloud decoder according to an embodiment of this application.

FIG. 20 is a schematic structural diagram of a point cloud encoder according to an embodiment of this application.

FIG. 21 is a schematic structural diagram of an electronic device according to an embodiment of this application.

### DESCRIPTION OF EMBODIMENTS

To make the objectives, technical solutions, and advantages of embodiments of this application clearer, specific technical solutions of this application are further described in detail below with reference to the accompanying drawings in embodiments of this application. The following embodiments are intended to illustrate this application, but are not intended to limit the scope of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following description, there are “some embodiments” that describe a subset of all possible embodiments, but it may be understood that “some embodiments” may be the same subset or different subsets of all possible embodiments and may be combined with each other in the case of no conflicts.

Frameworks and service scenarios of the point cloud encoder and the point cloud decoder described in embodiments of this application are intended to more clearly illustrate technical solutions of embodiments of this application and do not constitute a limitation on the technical solutions provided in the embodiments of this application. Those of ordinary skill in the art may understand that, with the evolution of point cloud encoders and point cloud decoders and the emergence of new service scenarios, the technical solutions provided in the embodiments of this application are also applicable to similar technical problems.

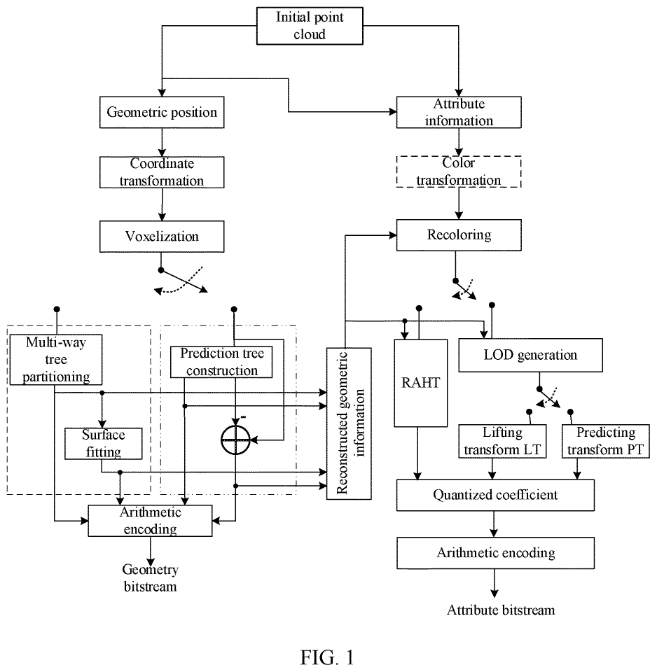

FIG. 1 is a schematic structural diagram of a point cloud encoder 1 in an MPEG G-PCC attribute encoding and decoding framework. As shown in FIG. 1, during a geometry encoding process, geometric information is subjected to coordinate transformation, such that the whole point cloud is contained within a bounding box, and the geometric information is then subjected to quantization. The quantization in this step mainly plays a scaling function. Due to rounding during quantization, a part of the point cloud has identical geometric information. Then, it is determined whether to remove duplicate points based on a parameter. The process of quantization and removal of duplicate points is also referred to as a voxelization process. Next, multi-way tree (for example, octree) partitioning or prediction tree construction is performed on the bounding box. In this process, arithmetic encoding is performed on points in leaf nodes generated by partitioning, to generate a binary geometric bitstream; or arithmetic encoding (surface fitting based on vertices) is performed on vertices generated by partitioning, to generate a binary geometric bitstream. In an attribute encoding process, after geometry encoding is already completed, and the geometric information is reconstructed, color transform needs to be performed first, to transform color information (that is, an example of attribute information) from an RGB color space to a YUV color space. Then, the point cloud is re-colored by using the reconstructed geometric information, allowing attribute information that is not encoded to correspond to the reconstructed geometric information. Attribute encoding is mainly performed on color information and/or reflectance information. In a process of encoding color information and/or reflectance information, there are mainly three transform methods. One method is distance-based transform that relies on level of detail (LOD) division, where the transform method is further divided into predicting transform (PT) of point cloud attribute information and lifting transform (LT) of point cloud attribute information. The second method is to directly perform region adaptive hierarchal transform (RAHT). In any one of these three methods, the attribute information is quantized and arithmetic encoded to generate a binary attribute bit stream.

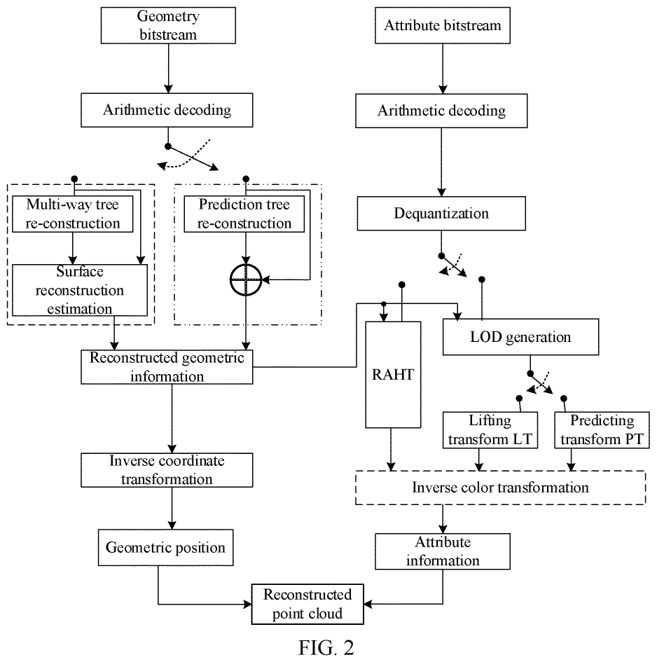

FIG. 2 is a schematic structural diagram of a point cloud decoder 2 in an MPEG G-PCC attribute encoding and decoding framework. As shown in FIG. 2, for an acquired binary bitstream, a geometric bitstream and an attribute bitstream in the binary bitstream are first separately decoded. During decoding of the geometric bitstream, geometric information of the point cloud is obtained through arithmetic decoding-multi-way tree reconstruction or prediction tree reconstruction-geometric reconstruction-inverse transform of coordinates. During decoding of the attribute bitstream, attribute information of the point cloud is obtained through arithmetic decoding-dequantization-LOD division or RAHT and/or inverse transform of colors. Based on the geometric information and the attribute information, to-be-encoded point cloud data is restored (that is, the point cloud is outputted). The attribute bitstream and the geometric bitstream shown in each of FIG. 1 and FIG. 2 may be understood as a point cloud bit stream.

It should be noted that, as shown in FIG. 1 or FIG. 2, MPEG G-PCC geometric encoding and decoding may be divided into multi-way tree-based geometry encoding and decoding (indicated by dashed boxes) and predictive geometry encoding and decoding (indicated by dash-dotted boxes).

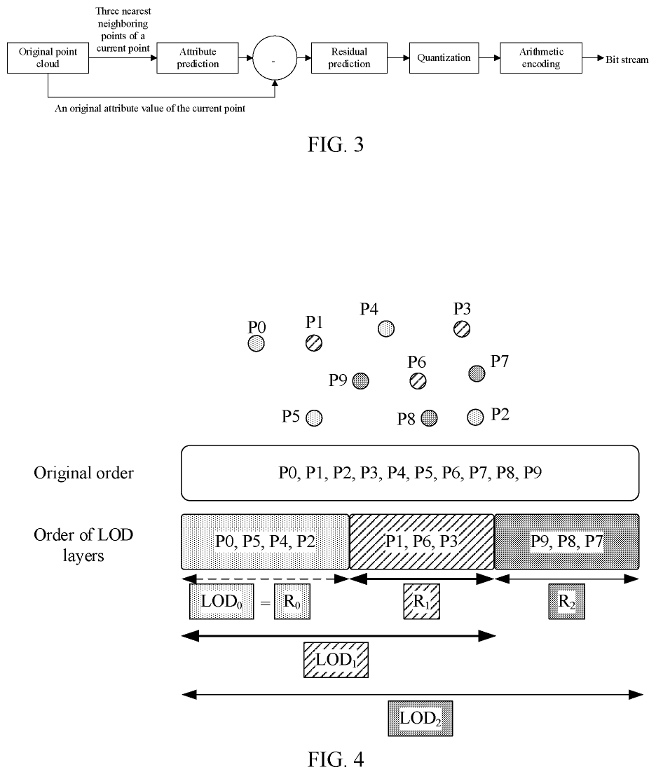

Optionally, FIG. 3 is a schematic diagram of an implementation process of PT encoding of point cloud attribute information. As shown in FIG. 3, the PT encoding process mainly includes: first, determining three reconstructed nearest neighboring points of a current point according to generation order of levels of detail (LOD) of an original point cloud; performing attribute prediction on the current point based on the three reconstructed nearest neighboring points, to obtain a predicted attribute value of the current point; second, obtaining an attribute residual value (that is, a prediction residual) of the current point by obtaining a difference between the predicted attribute value and an original attribute value of the current point; and finally, performing quantization and arithmetic encoding on the attribute residual value to generate a bit stream of attribute information.

A PT encoding process and a PT decoding process are described in detail below according to the above steps, where the PT encoding process includes the following steps 1 to 4.
Step 1: LOD generation.

Currently, the TMC13 software platform uses a distance-based LOD construction method. Specific steps for constructing an LOD are as follows (1) to (5):
(1) L Euclidean distances (dₗ)_{l=0 . . . L-1} are customized, and L refinement levels (Rₗ)_{l=0 . . . L-1} are obtained by division.
(2) All points in a frame of point cloud are marked as unvisited, and a visited point set V is set to an empty set.
(3) Generation of a refinement level Rₗ
   traversing all points, and if a current point has been visited, ignoring it;
   otherwise, calculating a minimum distance D from the current point to the point set V;
   if D is less than dₗ, ignoring the current point;
   otherwise, marking the current point as visited and adding it to Rₗ and V;
   repeating this process until all the points are traversed.
(4) the process in (3) is repeated for l+1 based on dₗ₊₁, so as to generate a refinement level Rₗ₊₁ until a refinement level R_{L-1}.
(5) A union of refinement levels R₀, R₁, . . . , R_{L-1} is obtained to obtain a level of detail LOD (that is,

$$L OD = {⋃}_{l = 0}^{L - 1} {R}_{l} ) ,$$

where (Rₗ)_{l=0 . . . . L-1} represents a refinement level, and L represents a quantity of levels of the LOD. As shown in FIG. 4, L is equal to 3.
Step 2: optimal predicted value selection:

After LOD construction is completed, first, three nearest neighboring points of the current point are found from encoded points in a current point cloud and a reference point cloud based on generation order of LODs, and reconstructed attribute values of the three nearest neighboring points are used as candidate predicted values of the current point. Then, an optimal candidate predicted value is selected from the candidate predicted values based on a rate-distortion optimal (RDO) and used as the predicted attribute value of the current point. For example, during encoding of an attribute value of a point P2 in FIG. 4, a reconstructed attribute value of the nearest neighboring point P4 is used as a candidate predicted value, and an index thereof is set to 1; reconstructed attribute values of the second nearest neighboring point P5_ref (that is, P5 is from the reference point cloud) and the third nearest neighboring point P0 are each used as a candidate predicted value, and indexes thereof are respectively set to 2 and 3; and a weighted average value of P0, P5_ref, and P4 is used as a candidate predicted value, and an index thereof is set to 0, as shown in Table 1. Finally, an optimal prediction variable is selected based on an RDO. A formula for the weighted averaging is expressed as the following formula (1):

$${\hat{a}}_{i} = Round ( {\sum }_{j = 0}^{2} \frac{{\tilde{w}}_{i j}}{{\sum }_{j = 0}^{2} {\tilde{w}}_{ij}} {\tilde{a}}_{j} ) ; \qquad ( 1 )$$

In the formula, \tilde{w}ᵢⱼ represents a spatial geometric weight from a neighboring point j to a current point i. The spatial geometric weight is determined according to the following formula (2):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 2 )$$

In the formula, âᵢ represents a predicted attribute value of the current point i, j represents an index of any one of the three nearest neighboring points, ãⱼ represents an attribute value obtained after reconstruction (namely, a reconstructed attribute value) of a nearest neighboring point j, xᵢ, yᵢ, zᵢ are geometric position coordinates of the current point i, and xᵢⱼ, yᵢⱼ, zᵢⱼ are geometric coordinates of the nearest neighboring point j.

TABLE 1
Candidate prediction samples for attribute encoding

| Prediction mode | Candidate predicted value |
|---|---|
| 0 | Weighted average value of reconstructed attribute |
| | values of three nearest neighboring points. |
| 1 | P4 (a reconstructed attribute value of the |
| | first nearest neighboring point) |
| 2 | P5_ref (a reconstructed attribute value |
| | of the second nearest neighboring point) |
| 3 | P0 (a reconstructed attribute value of the |
| | third nearest neighboring point) |

Step 3: attribute prediction residual (that is, attribute residual value) and quantization:

The predicted attribute value (âᵢ)_{i∈0 . . . k-1} of the current point i is obtained through the foregoing prediction (k is a total quantity of points in the point cloud). If (aᵢ)_{i∈0 . . . k-1} is an original attribute value of the current point, a formula for determining an attribute prediction residual (rᵢ)_{i∈0 . . . k-1} of the current point is as shown in the following formula (3):

rᵢ=aᵢ−âᵢ (3);

Further, the attribute prediction residual is quantized according to the following formula (4):

$${Q}_{i} = \frac{{r}_{i}}{Q s} ; \qquad ( 4 )$$

In the formula, Qᵢ represents the quantized attribute prediction residual of the current point i, Qs is a quantization step (Qs), which may be calculated based on a quantization parameter (QP) specified by CTC.
Step 4: reconstruction of the attribute value of the current point at the encoding end (that is, obtaining the reconstructed attribute value of the current point):

The purpose of the reconstruction at the encoding end is for attribute prediction of subsequent points. Before the attribute value is reconstructed, Qᵢ is first dequantized according to the following formula (5), where \hat{r}i is denoted as a dequantized attribute prediction residual:

\hat{r}ᵢ=Qᵢ×Qs (5);

\hat{r}ᵢ and the predicted attribute value ât are added to obtain the reconstructed attribute value ãⱼ of the point i, as shown in the following formula (6):

ãᵢ=\hat{r}ᵢ+âᵢ (6);

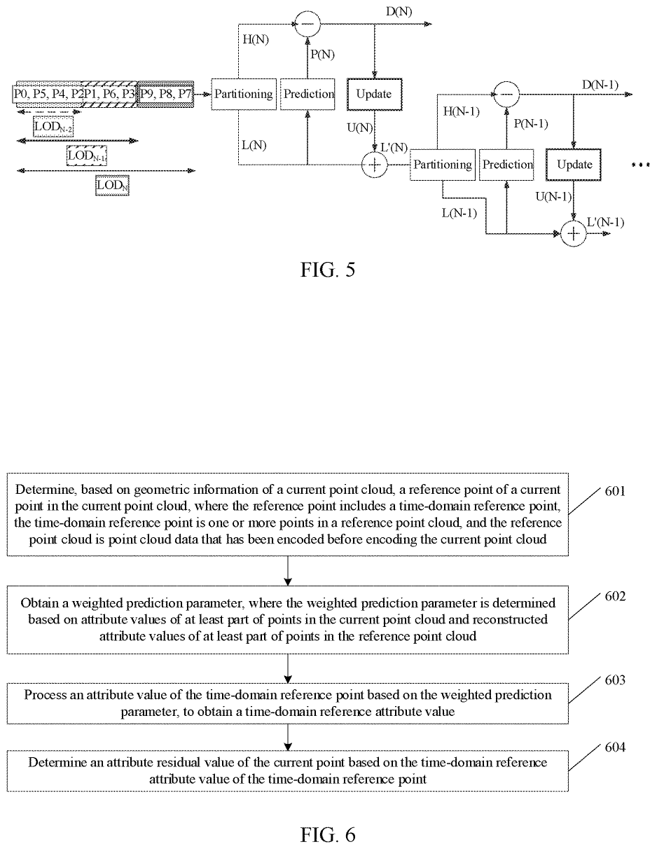

A lifting transform (LT) encoding process of point cloud attribute information is shown in FIG. 5. The lifting transform LT is also used to perform predictive encoding on an attribute of a point cloud based on LODs. A difference from the predicting transform PT is that the lifting transform LT first divides the LOD into high and low layers, performs prediction in reverse order of generating LOD layers, and updates quantization weights of points in the low LOD layers by introducing an update operator in the prediction process, thereby improving prediction accuracy. This is because an attribute value of a point in a low LOD layer is frequently used for prediction of an attribute value of a point in a high LOD layer, and the point in the low LOD layer should have greater influence.

An LT encoding process of is shown in steps 1 to 3 as follows:
Step 1: Partitioning process:

In the partitioning process, the complete LOD layer is divided into a low LOD layer L(N) and a high LOD layer H(N), where a Euclidean distance dₗ based on which L(N) is generated is greater than a Euclidean distance based on which H(N) is generated. If a point cloud has three LODs, that is,

$$LOD = {⋃}_{l = 0}^{3 - 1} {R}_{l} ,$$

$$l = 0 , 1 , 2 ,$$

after the division, (Rₗ)_{l=1,2} is the high LOD layer and is denoted as H(N), and (Rₗ)ₗ₌₀ is the low LOD layer and is denoted as L(N).
Step 2: Prediction process:

For a point in a high LOD layer, attribute information of its nearest neighboring point is selected from a low LOD layer of the current point cloud and the reference point cloud, and based on this, the predicted attribute value P(N) of the current point is determined, and the attribute prediction residual D(N) is as shown in the following formula (7):

D(N)=H(N)−P(N) (7);

In LT, there is only one prediction mode, which is the weighted average value of the three nearest neighboring points, as shown in the following formula (8):

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} ) ; \qquad ( 8 )$$

In the formula, \tilde{w}ᵢⱼ represents a spatial geometric weight from a neighboring point j to a current point i A calculation method is as shown in the following formula (9):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 9 )$$

In the formula, âᵢ represents a predicted attribute value of the current point i, j represents an index of any one of the three nearest neighboring points, ãⱼ represents an attribute value obtained after reconstruction of a nearest neighboring point j, xᵢ, yᵢ, zᵢ are geometric position coordinates of the current point i, and xᵢⱼ, yᵢⱼ, zᵢⱼ are geometric coordinates of the nearest neighboring point j.
Step 3: Update process:

The attribute prediction residual D(N) in the high LOD layer is updated to obtain U(N), and an attribute value of a point in the low LOD layer (that is, a current reconstructed attribute value of a point belonging to the current point cloud among the three nearest neighboring points of the current point) is subjected to lifting by using U(N), as shown in the following formula (10):

L′(N)=L(N)+U(N) (10);

The foregoing processes are continuously iterated in descending order of LODs until the lowest LOD layer is processed.

It may be understood that point cloud inter prediction encoding is applicable to dynamic point cloud data sets acquired by a LiDAR. The LiDAR system measures objects and terrain in the surrounding environment by using laser beams, and then converts these measurement results into point cloud data, where each point represents a discrete position in three-dimensional space. LiDAR point cloud data usually consists of geometric information and reflectance information. Reflectance, as an attribute value of a point, reflects echo intensity collected by a receiving device of a laser scanner, and is related to the surface material of a target, roughness, an incident angle direction, emission energy of an instrument, a laser wavelength, and a lighting condition during the collection process, and the like. LiDAR point clouds have a wide range of usage in various applications, including autonomous driving, map making, environmental sensing, building measurement, geological exploration, remote sensing, virtual reality, game development, and other fields. These data may be used to create high-resolution three-dimensional models, helping robots and autonomous vehicles with navigation, obstacle detection, and other tasks.

During the collection process, due to factors such as daylight conditions, nighttime lighting conditions, traffic light switching, vehicle lights, and weather conditions, average reflectance of each frame of a point cloud data set may fluctuate. Therefore, when a point cloud codec performs inter prediction, if a nearest neighboring point comes from a reference point cloud, it may lead to inaccurate prediction, thereby causing a decrease in reconstruction quality and redundancy in encoding bits. A fundamental reason is that, in the related technology, no compensation is performed on the nearest neighboring point in the reference point cloud, and its reconstructed value is directly used for prediction. Therefore, in the related technology, an ideal compression effect fails to be achieved when the average reflectance of each frame of the point cloud data set fluctuates.

An embodiment of this application provides an encoding method. The method may be applied to the point cloud encoder 1 shown in FIG. 1. FIG. 6 is a schematic diagram of an implementation process of an encoding method according to an embodiment of this application. As shown in FIG. 6, the method includes the following steps 601 to 604.
Step 601: Determine, based on geometric information of a current point cloud, a reference point of a current point in the current point cloud, where the reference point includes a time-domain reference point, the time-domain reference point is one or more points in a reference point cloud, and the reference point cloud is point cloud data that has been encoded before encoding the current point cloud.
Step 602: Obtain a weighted prediction parameter, where the weighted prediction parameter is determined based on attribute values of at least part of points in the current point cloud and reconstructed attribute values of at least part of points in the reference point cloud.
Step 603: Process an attribute value of the time-domain reference point based on the weighted prediction parameter, to obtain a time-domain reference attribute value.
Step 604: Determine an attribute residual value of the current point based on the time-domain reference attribute value of the time-domain reference point.

In embodiments of this application, before determining the attribute residual value of the current point based on the reference point of the current point, a point cloud encoder first processes the attribute value of a time-domain reference point among reference points of the current point based on the weighted prediction parameter, and determines the attribute residual value of the current point based on the time-domain reference attribute value of the time-domain reference point. In this way, since the weighted prediction parameter is determined based on attribute values of at least part of points in a current point cloud and reconstructed attribute values of at least part of points in a reference point cloud, and the attribute value of the time-domain reference point is first processed based on the weighted prediction parameter, the attribute residual value obtained based on the processing result is more accurate, thereby being conducive to saving encoding bit overheads.

The following describes further optional implementations and related terms of the steps above.

In step 601, the reference point of the current point in the current point cloud is determined based on the geometric information of the current point cloud, where the reference point includes the time-domain reference point, the time-domain reference point is one or more points in the reference point cloud, and the reference point cloud is point cloud data that has been encoded before encoding the current point cloud.

In an example, the current point cloud may be understood as point cloud data of a current frame. The reference point cloud may be understood as point cloud data of a reference frame.

Optionally, in some embodiments, before determining the reference point of the current point, the point cloud encoder is required to construct an LOD of the current point cloud. Certainly, for a frame of point cloud, only one LOD is required to be constructed, that is, before a reference point of the 1^{st} point in the current point cloud is determined, that is, before an attribute value of the 1^{st} point in the current point cloud is encoded, the LOD of the current point cloud is first constructed based on the geometric information of the current point cloud. Subsequently, for each point in the current point cloud, an attribute value thereof is encoded based on the constructed LOD.

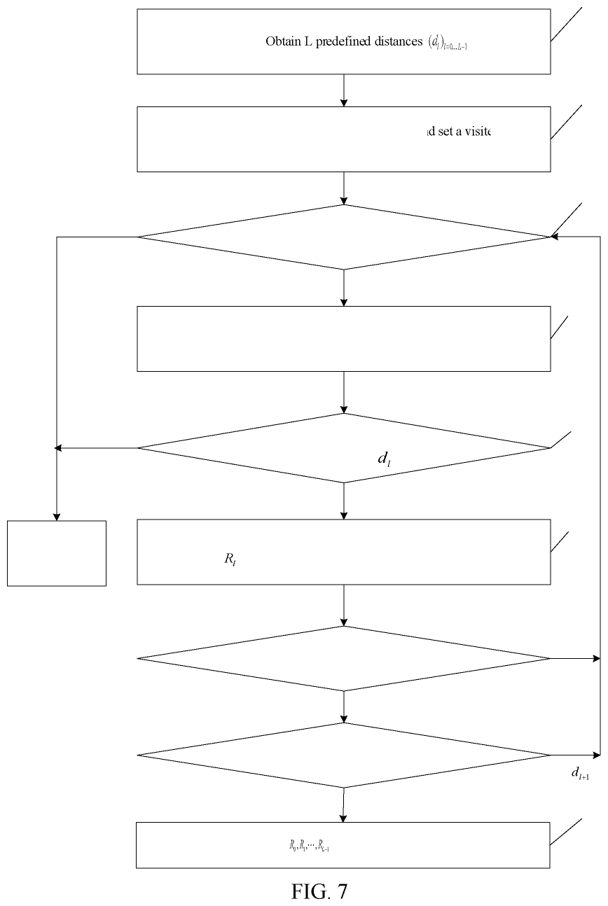

Optionally, in some embodiments, the point cloud encoder may construct the LOD of the current point cloud based on distances. As shown in FIG. 7, the point cloud encoder may construct the LOD of the current point cloud through the following steps 701 to 707.

In step 701, L predefined distances (dₗ)_{l=0 . . . . L-1} are obtained, where one dₗ corresponds to one refinement level, so that L refinement levels (Rₗ)_{l=0 . . . L-1} may be obtained by division, where L is greater than 1.

For example, dₗ may be understood as an l^{th} predefined distance. The predefined distance may be a Euclidean distance or a cosine distance or another parameter that represents a geometric distance between two spatial coordinates.

In step 702, all points in the current point cloud are marked as unvisited, and a visited point set V is set to an empty set; and then a first process is performed, where the first process includes the following steps 703 to 706.

In step 703, all points are traversed, and if the current point has been visited, it is ignored; otherwise, step 703 is performed.

In step 704, a minimum distance D between the current point and a point in the point set V is calculated.

It may be understood that the minimum distance D has the same attribute as dₗ, for example, if dₗ is a Euclidean distance, the minimum distance D is also a Euclidean distance. If dₗ is a cosine distance, the minimum distance D is also a cosine distance.

In step 705, whether the minimum distance D is less than dₗ is determined, and if yes, the current point is ignored; and otherwise, step 706 is performed.

In step 706, the current point is marked as visited, and the current point is added to an l refinement level Rₗ and the point set V.

Steps 703 to 706 continue to be performed for a next point until all points in the current point cloud are traversed, and steps 703 to 706 are performed based on dₗ₊₁, to obtain a refinement level Rₗ₊₁, until L refinement levels (Rₗ)_{l=0 . . . . L-1} are obtained, and then step 707 is to be performed.

In step 707, a union of refinement levels R₀, R₁, . . . , R_{L-1} is obtained to obtain a level of detail LOD (that is,

$$LOD = {⋃}_{l = 0}^{L - 1} {R}_{l} ) ,$$

where (Rₗ)_{l=0 . . . . L-1} represents a refinement level, and L represents a quantity of levels of the LOD.

After the LOD of the current point cloud is obtained, the point cloud encoder may encode an attribute value of a point in the current point cloud. In some embodiments, the point cloud encoder may implement step 601 as follows: determining a current refinement level, where the current refinement level is a refinement level of the current point in an LOD of the current point cloud; and determining the reference point of the current point from at least one first refinement level in the LOD of the current point cloud, encoded points in the current refinement level and/or at least one second refinement level in an LOD of the reference point cloud, where encoding order of the at least one first refinement level is prior to that of the current refinement level, and a predefined distance (such as a Euclidean distance or cosine distance) based on which the second refinement level is generated corresponds to and is equal to a predefined distance based on which the first refinement level is generated.

Optionally, in some embodiments, the point cloud encoder may determine the reference point of the current point from the at least one first refinement level, encoded points in the current refinement level, and the at least one second refinement level. In some other embodiments, the point cloud encoder may determine the reference point of the current point from the at least one first refinement level and the at least one second refinement level. In some other embodiments, the point cloud encoder may determine the reference point of the current point from encoded points in the current refinement level and the at least one second refinement level.

In embodiments of this application, no limitation is imposed on which point or points can serve as the reference point of the current point. For example, a point with a distance (namely, a geometric distance) to the current point less than or equal to a distance threshold is used as the reference point of the current point. In another example, one or more points with the smallest distance from the current point (that is, nearest neighboring points) may be used as the reference point of the current point.

In other words, in some embodiments, the reference point of the current point is one or more first nearest neighboring points of the current point (that is, the one or more points with the smallest distance from the current point), and the one or more first nearest neighboring points are from the current point cloud and/or the reference point cloud. In embodiments of this application, the one or more first nearest neighboring points may be N first nearest neighboring points, where N is greater than 1, and N may be a predefined numerical value.

In embodiments of this application, a relationship between the at least one first refinement level and the current refinement level is not limited, which is related to encoding order of the current point cloud. For example, if the encoding order of the current point cloud is R_{L-1}, R_{L-2}, . . . , R₀, a predefined distance based on which the at least one first refinement level is generated is less than a predefined distance based on which the current refinement level is generated. For another example, if the encoding order of the current point cloud is R₀, R₁, . . . , R_{L-1}, the predefined distance based on which the at least one first refinement level is generated is greater than the predefined distance based on which the current refinement level is generated. In summary, the encoding order of the at least one first refinement level is prior to that of the current refinement level.

In step 602, the weighted prediction parameter is obtained, where the weighted prediction parameter is determined based on attribute values of at least part of points in the current point cloud and reconstructed attribute values of at least part of points in the reference point cloud.

In embodiments of this application, the weighted prediction parameter may be applicable to attribute encoding of every point in the current point cloud, or may be applicable only to attribute encoding of part of points in the current point cloud.

For a scheme where the weighted prediction parameter is applicable only to the attribute encoding of part of the points in the current point cloud, in a possible implementation, if the weighted prediction parameter is determined based on attribute values of a first part of points in the current point cloud and reconstructed attribute values of a first part of points in the reference point cloud, the determined weighted prediction parameter is used for encoding the attribute values of the first part of points in the current point cloud; if the weighted prediction parameter is determined based on attribute values of a second part of points in the current point cloud and reconstructed attribute values of a second part of points in the reference point cloud, the determined weighted prediction parameter is used for encoding the attribute values of the second part of points in the current point cloud. Then, when writing the weighted prediction parameter into a bit stream, the point cloud encoder is also required to indicate which part of points the weighted prediction parameter is applicable to.

For a scheme where the weighted prediction parameter is applicable to attribute encoding of every point in the current point cloud, before starting the attribute encoding of the current point cloud, the point cloud encoder may first determine the weighted prediction parameter used for the current point cloud based on attribute values of at least part of points in the current point cloud and reconstructed attribute values of at least part of points in the reference point cloud. Subsequently, when the encoding method is performed for every point in the current point cloud, the weighted prediction parameter is directly obtained from the corresponding storage area for use. Optionally, in some embodiments, the point cloud encoder may write the weighted prediction parameter into a bit stream before writing an attribute residual value of the 1^{st} point in the current point cloud into the bit stream. Alternatively, the weighted prediction parameter may be written into a bit stream after writing an attribute residual value of the 1^{st} point in the current point cloud into the bit stream. The point cloud encoder may alternatively write the weighted prediction parameter into a bit stream again before and/or after writing an attribute residual value of another point in the current point cloud into the bit stream.

In a possible implementation, the point cloud encoder may determine the weighted prediction parameter as follows: fitting the mapping relationship between attribute values of at least part of points in the current point cloud and reconstructed attribute values of at least part of points in the reference point cloud, to obtain the weighted prediction parameter, where the attribute values of at least part of the points in the current point cloud may be true values of the points, that is, collected attribute values. The true values may be collected original attribute values or values obtained by preprocessing (such as filtering) of original attribute values.

For example, in some embodiments, the weighted prediction parameter includes a weighting factor and/or an offset.

For example, aᵢ (i=0, 1, . . . , n) is denoted as an attribute value of an i^{th} point in the current point cloud, where n is a quantity of points in the current point cloud. a_refⱼ (j=0, 1, . . . , m) is denoted as a reconstructed attribute value of a j^{th} point in the reference point cloud, where m is a quantity of points in the reference point cloud, and the weighting factor q and the offset w can be obtained by fitting according to the following formula (11):

aᵢ=q×a_refⱼ+w (11);

In step 603, an attribute value (for example, a reconstructed attribute value) of the time-domain reference point is processed based on the weighted prediction parameter, to obtain the time-domain reference attribute value.

Optionally, in some embodiments, the point cloud encoder may implement step 603 as follows: determining a first product of the weighting factor and a reconstructed attribute value of the time-domain reference point; and offsetting the first product based on the offset, to obtain the time-domain reference attribute value.

For example, the time-domain reference attribute value of the time-domain reference point may be obtained according to the following formula (12):

tempⱼ=q×ãⱼ+w (12);

In the formula, tempⱼ refers to a time-domain reference attribute value of a time-domain reference point j, and ãⱼ refers to a reconstructed attribute value of the time-domain reference point j.

In step 604, an attribute residual value of the current point is determined based on the time-domain reference attribute value of the time-domain reference point.

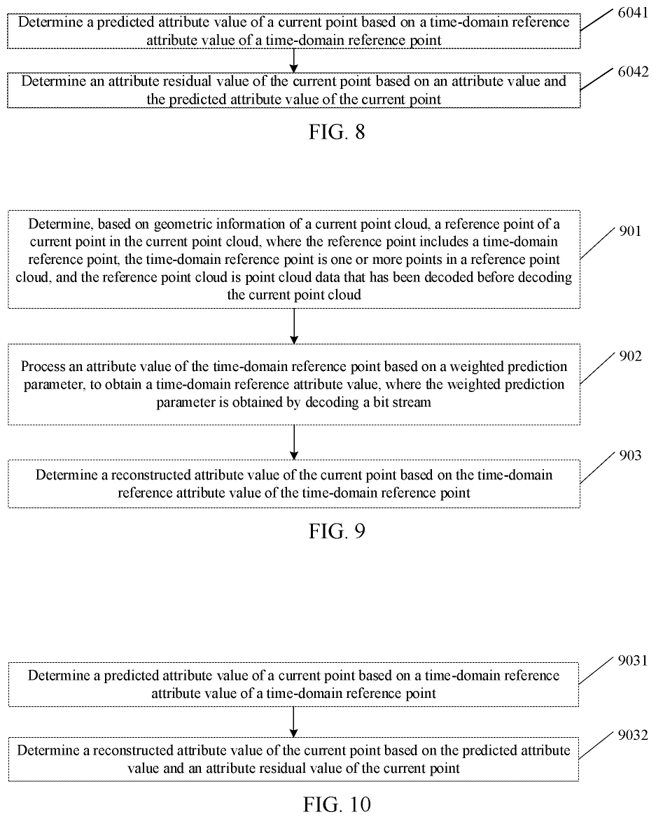

In some embodiments, as shown in FIG. 8, the point cloud encoder may implement step 604 through the following steps 6041 and 6042.

In step 6041, a predicted attribute value of the current point is determined based on the time-domain reference attribute value of the time-domain reference point.

In embodiments of this application, the point cloud encoder may determine the predicted attribute value of the current point using Embodiment 1 or Embodiment 2 below.

Optionally, in Embodiment 1, the point cloud encoder may implement step 6041 as follows: determining a candidate predicted value of the current point based on the time-domain reference attribute value of the time-domain reference point; determining the predicted attribute value of the current point based on a rate distortion cost of the candidate predicted value of the current point. For example, in some embodiments, the predicted attribute value of the current point is equal to the candidate predicted value with the minimum rate distortion cost.

It may be understood that the reference point of the current point may include a time-domain reference point and/or a spatial-domain reference point, the spatial-domain reference point is one or more points in the current point cloud, and the spatial-domain reference point is a point encoded before encoding the current point. For a scheme where the reference point of the current point, that is, the one or more first nearest neighboring points, is obtained based on LOD search, the time-domain reference point is from the second refinement level, and the spatial-domain reference point is from the first refinement level or encoded points in the current refinement level.

For a case in which the reference point of the current point includes a time-domain reference point and a spatial-domain reference point, for Embodiment 1, further, in some embodiments, the point cloud encoder may determine a candidate predicted value of the current point as follows: determining the candidate predicted value of the current point based on the time-domain reference attribute value of the time-domain reference point and a reconstructed attribute value of the spatial-domain reference point.

For example, in some embodiments, the candidate predicted value of the current point includes the time-domain reference attribute value of the time-domain reference point, a weighted average value of the time-domain reference attribute value of the time-domain reference point, and the reconstructed attribute value of the spatial-domain reference point and/or a weighted average value of the time-domain reference attribute value of the time-domain reference point and the reconstructed attribute value of the spatial-domain reference point.

In some embodiments, the method further includes: determining a prediction mode of the current point based on an index value of the candidate predicted value with the minimum rate distortion cost among candidate predicted values of the current point; and generating a bit stream based on the prediction mode.

In a possible implementation, the prediction mode of the current point is equal to the index value of the candidate predicted value with the minimum rate distortion cost among the candidate predicted values of the current point, that is, the index value is used to represent the prediction mode of the current point, and the prediction mode written into the bit stream is the index value.

In embodiments of this application, the index value of the candidate predicted value of the current point is determined based on arrangement order of the candidate predicted values of the current point, and the index value of the candidate predicted value may be equal to an arrangement position of the candidate predicted value among the candidate predicted values of the current point. In embodiments of this application, the arrangement order of the candidate predicted values of the current point is not limited. For example, the reference point of the current point is four first nearest neighboring points, and the arrangement order of the candidate predicted values of the current point is as shown in Table 2 below.

TABLE 2

| Index value | |
|---|---|
| of prediction | Candidate predicted value |
| 0 | Weighted average value of attribute values of four first |
| | nearest neighboring points |
| 1 | Attribute value of the first nearest neighboring point |
| 2 | Attribute value of the second nearest neighboring point |
| 3 | Attribute value of the third nearest neighboring point |
| 4 | Attribute value of the fourth nearest neighboring point |

It should be noted that, in Table 2, if the four first nearest neighboring points include both time-domain reference points and spatial-domain reference points, the candidate predicted value corresponding to the index value 1 is a weighted average value of time-domain reference attribute values of all the time-domain reference points and reconstructed attribute values of all the spatial-domain reference points. If the four first nearest neighboring points include only time-domain reference points, the candidate predicted value corresponding to the index value 1 is a weighted average value of time-domain reference attribute values of all the time-domain reference points. If the four first nearest neighboring points include only spatial-domain reference points, the candidate predicted value corresponding to the index value 1 is a weighted average value of reconstructed attribute values of all the spatial-domain reference points.

In Table 2, the so-called first nearest neighboring point refers to the point closest to the current point among the four first nearest neighboring points, and the so-called second nearest neighboring point refers to the point second closest to the current point among the four first nearest neighboring points, and so on. In Table 2, if the first (second, third, or fourth) nearest neighboring point is a time-domain reference point, an attribute value of the first (second, third, or fourth) nearest neighboring point refers to a time-domain reference attribute value of the point. If the first (second, third, or fourth) nearest neighboring point is a spatial-domain reference point, an attribute value of the first (second, third, or fourth) nearest neighboring point refers to a reconstructed attribute value of the point.

Certainly, the arrangement order of the candidate predicted values of the current point in Table 2 above may alternatively be any other order, and the embodiments of this application are not limited to the arrangement rule shown in Table 2.

Optionally, in Embodiment 2, the reference point further includes a spatial-domain reference point, and the spatial-domain reference point is one or more encoded points in the current point cloud. The point cloud encoder may also implement step 6041 (determining the predicted attribute value of the current point based on the time-domain reference attribute value of the time-domain reference point) as follows: determining the predicted attribute value of the current point based on the time-domain reference attribute value of the time-domain reference point and a reconstructed attribute value of the spatial-domain reference point.

Optionally, in Embodiment 2, the point cloud encoder may determine the predicted attribute value of the current point by using the method described in Embodiment 1 above, or may determine the predicted attribute value of the current point as follows: determining the predicted attribute value of the current point based on a weighted average value of the time-domain reference attribute value of the time-domain reference point and the reconstructed attribute value of the spatial-domain reference point.

For example, in some embodiments, the predicted attribute value of the current point is equal to the weighted average value. In some other embodiments, the predicted attribute value of the current point may alternatively be equal to an optimized weighted average value. In a possible implementation, the point cloud encoder may optimize the weighted average value as follows: multiplying the weighted average value by a second numerical value, or multiplying the weighted average value by a second numerical value and then adding a third numerical value to the product, where the second numerical value and the third numerical value may be predefined numerical values.

Optionally, in Embodiment 2, after determining the attribute residual value of the current point, the point cloud encoder may update the reconstructed attribute value (the reconstructed attribute value herein refers to a current reconstructed attribute value of the spatial-domain reference point) of the spatial-domain reference point based on the attribute residual value of the current point.

In embodiments of this application, no limitation is imposed on a method for updating the reconstructed attribute value of the spatial-domain reference point. In some embodiments, the attribute residual value of the current point may be converted into a weighting coefficient, and then the weighting coefficient is multiplied by the reconstructed attribute value of the spatial-domain reference point, thereby updating the reconstructed attribute value of the spatial-domain reference point.

In some other embodiments, the point cloud encoder may update the reconstructed attribute value of the spatial-domain reference point as follows: updating the attribute residual value D(N) of the current point to obtain U(N); updating the reconstructed attribute value of the spatial-domain reference point by using U(N), for example, updating the reconstructed attribute value of the spatial-domain reference point according to the following formula (13):

L′(N)=L(N)+U(N) (13);

In the formula, L′(N) represents an updated reconstructed attribute value of the spatial-domain reference point, and L(N) represents a reconstructed attribute value of the spatial-domain reference point before the update.

In step 6042, the attribute residual value of the current point is determined based on an attribute value and the predicted attribute value of the current point.

In step 6042, the attribute value of the current point refers to a true value of the current point, that is, a collected attribute value, and the true value may be a collected original attribute value, or may be a value obtained by preprocessing (such as filtering) of the original attribute value.

In a possible implementation, the point cloud encoder may determine the attribute residual value D(N) of the current point according to the following formula (14):

D(N)=H(N)−P(N) (14);

In the formula, H(N) is the attribute value of the current point, and P(N) is the predicted attribute value of the current point.

In some embodiments, after the attribute residual value of the current point is obtained, the method further includes: generating a bit stream based on the attribute residual value of the current point.

Optionally, in some embodiments, the point cloud encoder may quantize the attribute residual value of the current point, and perform arithmetic encoding on the quantized attribute residual value to generate a bit stream.

Certainly, in some other embodiments, the point cloud encoder may not quantize the attribute residual value of the current point, and directly perform arithmetic encoding on the value to generate a bit stream.

An embodiment of this application provides a decoding method. The method may be applied to the point cloud decoder 2 shown in FIG. 2. FIG. 9 is a schematic diagram of an implementation process of a decoding method according to an embodiment of this application. As shown in FIG. 9, the method includes the following steps 901 to 903.
Step 901: Determine, based on geometric information of a current point cloud, a reference point of a current point in the current point cloud, where the reference point includes a time-domain reference point, the time-domain reference point is one or more points in a reference point cloud, and the reference point cloud is point cloud data that has been decoded before decoding the current point cloud.
Step 902: Process an attribute value of the time-domain reference point based on a weighted prediction parameter, to obtain a time-domain reference attribute value, where the weighted prediction parameter is obtained by decoding a bit stream.
Step 903: Determine a reconstructed attribute value of the current point based on the time-domain reference attribute value of the time-domain reference point.

In embodiments of this application, before the reconstructed attribute value of the current point is determined based on the attribute value of the time-domain reference point, the attribute value of the time-domain reference point is first processed based on the weighted prediction parameter, and then the reconstructed attribute value of the current point is determined based on the processing result (that is, the time-domain reference attribute value of the time-domain reference point). In this way, it is conducive to improving accuracy of the reconstructed attribute value of the current point, thereby improving attribute reconstruction quality of the current point cloud.

It may be understood that the decoding method shown in FIG. 9 corresponds to the encoding method shown in FIG. 6. Therefore, the description of the decoding method shown in FIG. 9 and further or additional implementations of this method is similar to the description of the encoding method shown in FIG. 6 and further or additional implementations of this method. For technical details not disclosed in embodiments of the decoding method, reference is made to the description of the embodiments of the foregoing encoding method for understanding.

The following describes further optional implementations and related terms of the steps shown in FIG. 9, and the like.

In step 901: the reference point of the current point in the current point cloud is determined based on the geometric information of the current point cloud, where the reference point includes the time-domain reference point, the time-domain reference point is one or more points in the reference point cloud, and the reference point cloud is point cloud data that has been decoded before decoding the current point cloud.

In an example, the current point cloud may be understood as point cloud data of the current point cloud. The reference point cloud may be understood as point cloud data of the reference point cloud.

Optionally, in some embodiments, before determining the reference point of the current point, the point cloud decoder is required to construct an LOD of the current point cloud. Certainly, for a frame of point cloud, only one LOD is required to be constructed, that is, before a reference point of the 1^{st} point in the current point cloud is determined, that is, before an attribute value of the 1^{st} point in the current point cloud is decoded, the LOD of the current point cloud is first constructed based on the geometric information of the current point cloud. Subsequently, for each point in the current point cloud, an attribute value thereof is decoded based on the constructed LOD.

Optionally, in some embodiments, the method for the point cloud decoder to construct the LOD of the current point cloud is the same as the foregoing method for the point cloud encoder to construct the LOD of the current point cloud. Specifically, the construction of the LOD may be implemented with reference to the method shown in FIG. 7, and is not repeated here.

After obtaining the LOD of the current point cloud, the point cloud decoder may reconstruct an attribute value of a point in the current point cloud. In some embodiments, the point cloud decoder may implement step 901 as follows: determining a current refinement level, where the current refinement level is a refinement level of the current point in an LOD of the current point cloud; and determining the reference point of the current point from at least one first refinement level in the LOD of the current point cloud, decoded points in the current refinement level and/or at least one second refinement level in an LOD of the reference point cloud, where decoding order of the at least one first refinement level is prior to that of the current refinement level, and a predefined distance (such as a Euclidean distance or cosine distance) based on which the second refinement level is generated corresponds to and is equal to a predefined distance based on which the first refinement level is generated.

In some embodiments, the point cloud decoder may determine the reference point of the current point from the at least one first refinement level, decoded points in the current refinement level, and the at least one second refinement level. In some other embodiments, the point cloud decoder may determine the reference point of the current point from the at least one first refinement level and the at least one second refinement level. In some other embodiments, the point cloud decoder may determine the reference point of the current point from decoded points in the current refinement level and the at least one second refinement level.

In embodiments of this application, no limitation is imposed on which point or points can serve as the reference point of the current point. For example, a point with a distance (namely, a geometric distance) to the current point less than or equal to a distance threshold is used as the reference point of the current point. In another example, one or more points with the smallest distance from the current point (that is, nearest neighboring points) may be used as the reference point of the current point.

In other words, in some embodiments, the reference point is one or more first nearest neighboring points of the current point (that is, the one or more points with the smallest distance from the current point), and the one or more first nearest neighboring points are from the current point cloud and/or the reference point cloud. In embodiments of this application, the one or more first nearest neighboring points may be N first nearest neighboring points, where N is greater than 1, and N may be a predefined numerical value.

In embodiments of this application, a relationship between the at least one first refinement level and the current refinement level is not limited, which is related to decoding order of the current point cloud. For example, if the decoding order of the current point cloud is R_{L-1}, R_{L-2}, . . . , R₀, a predefined distance based on which the at least one first refinement level is generated is less than a predefined distance based on which the current refinement level is generated. For another example, if the decoding order of the current point cloud is R₀, R₁, . . . , R_{L-1} the predefined distance based on which the at least one first refinement level is generated is greater than the predefined distance based on which the current refinement level is generated. In summary, the decoding order of the at least one first refinement level is prior to that of the current refinement level.

In step 902, the attribute value of the time-domain reference point is processed based on the weighted prediction parameter, to obtain the time-domain reference attribute value, where the weighted prediction parameter is obtained by decoding a bit stream.

In embodiments of this application, the weighted prediction parameter may be applicable to attribute reconstruction/attribute decoding of every point in the current point cloud, or may be applicable only to attribute reconstruction/attribute decoding of part of points in the current point cloud.

For a scheme where the weighted prediction parameter is applicable only to attribute reconstruction of part of points in the current point cloud, in a possible implementation, the point cloud decoder determines, based on the decoded bit stream, which part of points the weighted prediction parameter is applicable to, and performs attribute reconstruction on that part of points based on the weighted prediction parameter.

For a scheme where the weighted prediction parameter is applicable to attribute encoding of every point in the current point cloud, optionally, in some embodiments, the weighted prediction parameter is determined by decoding the bit stream before decoding an attribute residual value of the 1^{st} point in the current point cloud. The point cloud decoder may, before starting attribute reconstruction of the current point cloud, first decode the bit stream to determine the weighted prediction parameter and write it into a storage area; and then, when executing the encoding method for every point in the current point cloud, directly obtains the weighted prediction parameter from the corresponding storage area for use.

In some embodiments, the weighted prediction parameter is used to represent a mapping relationship between attribute values of at least part of points in the current point cloud and reconstructed attribute values of at least part of points in the reference point cloud.

In some embodiments, the weighted prediction parameter is a fitting coefficient obtained by fitting the mapping relationship between attribute values of at least part of points in the current point cloud and reconstructed attribute values of at least part of points in the reference point cloud.

In some embodiments, the weighted prediction parameter includes a weighting factor and/or an offset.

In some embodiments, the point cloud decoder may implement step 903 as follows: determining a first product of the weighting factor and a reconstructed attribute value of the time-domain reference point; and offsetting the first product based on the offset, to obtain the time-domain reference attribute value.

The time-domain reference attribute value of the time-domain reference point is determined in a same manner as that on the encoding end, which is not repeated here.

In step 903, the reconstructed attribute value of the current point is determined based on the time-domain reference attribute value of the time-domain reference point.

In some embodiments, the method further includes: decoding a bit stream to obtain an attribute residual value of the current point.

In a possible implementation, the point cloud decoder may perform arithmetic decoding on the bit stream carrying the attribute residual value, and then the value obtained by arithmetic decoding is dequantized, to obtain the attribute residual value of the current point.

As shown in FIG. 10, the point cloud decoder may implement step 903 through the following steps 9031 and 9032.

In step 9031, a predicted attribute value of the current point is determined based on the time-domain reference attribute value of the time-domain reference point.

In embodiments of this application, the point cloud decoder may determine the predicted attribute value of the current point by using Embodiment 3 or Embodiment 4 below. Embodiment 3 is decoding operations corresponding to Embodiment 1 above. For technical details not disclosed in Embodiment 3, reference may be made to the description of Embodiment 1 and further or additional implementations of Embodiment 1 for understanding.

Optionally, in Embodiment 3, the point cloud decoder may implement step 9031 as follows: determining a candidate predicted value of the current point based on the time-domain reference attribute value of the time-domain reference point; decoding a bit stream to determine a prediction mode of the current point; and determining the predicted attribute value of the current point based on the prediction mode and the candidate predicted value of the current point.

It may be understood that the reference point of the current point may include a time-domain reference point and/or a spatial-domain reference point, and the spatial-domain reference point is one or more points in the current point cloud, and the spatial-domain reference point is a point encoded before decoding the current point. For a scheme where the reference point of the current point, that is, the one or more first nearest neighboring points, is obtained based on LOD search, the time-domain reference point is from the second refinement level, and the spatial-domain reference point is from the first refinement level or encoded points in the current refinement level.

For a case in which the reference point of the current point includes a time-domain reference point and a spatial-domain reference point, for Embodiment 3, further, in some embodiments, the point cloud decoder may determine a candidate predicted value of the current point as follows: determining the candidate predicted value of the current point based on the time-domain reference attribute value of the time-domain reference point and a reconstructed attribute value of the spatial-domain reference point.

For example, in some embodiments, the candidate predicted value of the current point includes the time-domain reference attribute value of the time-domain reference point, a weighted average value of the time-domain reference attribute value of the time-domain reference point, and the reconstructed attribute value of the spatial-domain reference point and/or a weighted average value of the time-domain reference attribute value of the time-domain reference point and the reconstructed attribute value of the spatial-domain reference point.

For example, in some embodiments, the predicted attribute value of the current point is equal to a candidate predicted value corresponding to the prediction mode.

It may be understood that, at the encoding end, the prediction mode written into the bit stream is an index value of the candidate predicted value with the minimum rate distortion cost among the candidate predicted values of the current point. The index value of the candidate predicted value of the current point is determined based on arrangement order of the candidate predicted values of the current point. The arrangement order of the candidate predicted values of the current point at the decoding end is the same as that at the encoding end. Therefore, arrangement order of candidate predicted values of the current point and determination of index values of the candidate predicted values at the decoding end may be understood with reference to the description at the encoding end.

In Embodiment 4, the reference point further includes a spatial-domain reference point. The spatial-domain reference point is one or more decoded points in the current point cloud. The point cloud decoder may implement step 9031 as follows: determining the predicted attribute value of the current point based on the time-domain reference attribute value of the time-domain reference point and a reconstructed attribute value of the spatial-domain reference point.

Optionally, in Embodiment 4, the point cloud decoder may determine the predicted attribute value of the current point by using the method described in Embodiment 1 above, or may determine the predicted attribute value of the current point as follows: determining the predicted attribute value of the current point based on a weighted average value of the time-domain reference attribute value of the time-domain reference point and the reconstructed attribute value of the spatial-domain reference point.

For example, in some embodiments, the predicted attribute value of the current point is equal to the weighted average value. In some other embodiments, the predicted attribute value of the current point may alternatively be equal to an optimized weighted average value. In a possible implementation, the point cloud encoder may optimize the weighted average value as follows: multiplying the weighted average value by a second numerical value, or multiplying the weighted average value by a second numerical value and then adding a third numerical value to the product, where the second numerical value and the third numerical value may be predefined numerical values.

Optionally, in Embodiment 4, before determining the predicted attribute value of the current point based on the time-domain reference attribute value of the time-domain reference point and the reconstructed attribute value of the spatial-domain reference point, the point cloud decoder updates a reconstructed attribute value of a point in the at least one first refinement level based on an attribute residual value of a point in the current refinement level.

It may be understood that, unlike the encoding end, at the decoding end, after the attribute residual value is obtained from the decoded bit stream, a reconstructed attribute value of a point in the at least one first refinement level is first updated, and then attribute prediction is performed based on the updated result.

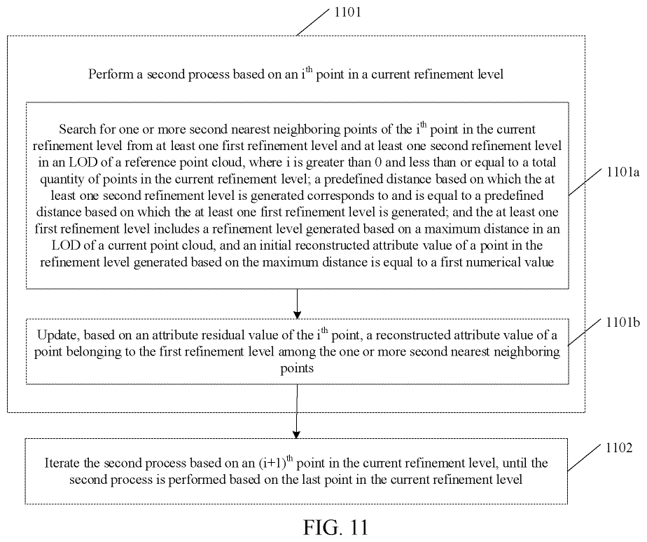

Optionally, in some embodiments, as shown in FIG. 11, the point cloud decoder may update a reconstructed attribute value of a point in the at least one first refinement level through the following steps 1101 to 1102:

In step 1101, a second process is performed based on an i^{th} point in the current refinement level, where the second process includes the following steps 1101a and 1101b.

In step 1101a, one or more second nearest neighboring points of the i^{th} point in the current refinement level are determined from the at least one first refinement level and the at least one second refinement level in the LOD of the reference point cloud, where i is greater than 0 and less than or equal to a total quantity of points in the current refinement level; a predefined distance based on which the at least one second refinement level is generated corresponds to and is equal to a predefined distance based on which the at least one first refinement level is generated; and the at least one first refinement level includes a refinement level generated based on a maximum distance in the LOD of the current point cloud, and an initial reconstructed attribute value of a point in the refinement level generated based on the maximum distance is equal to a first numerical value.

In step 1101b, a reconstructed attribute value of a point belonging to the first refinement level among the one or more second nearest neighboring points is updated based on an attribute residual value of the i^{th} point.

For example, in some embodiments, the point cloud decoder may implement step 1101b as follows: updating the attribute residual value D(N) of the i^{th} point (herein, the attribute residual value is a dequantized attribute residual value) to obtain U(N); updating a reconstructed attribute value of a point belonging to the first refinement level among the one or more second nearest neighboring points based on U(N), for example, updating the reconstructed attribute value of the point belonging to the first refinement level among the one or more second nearest neighboring points according to the following formula (15):

L′(N)=L(N)+U(N) (15);

In the formula (15), L′(N) is an updated reconstructed attribute value of a point belonging to the first refinement level among the one or more second nearest neighboring points, and L(N) is a reconstructed attribute value of the point before the update.

In step 1102, the second process is iterated based on an (i+1)^{th} point in the current refinement level, until the second process is performed based on the last point in the current refinement level, and based on this, a predicted attribute value of each point in the current refinement level starts to be determined, for example, the predicted attribute value of the current point is determined based on the time-domain reference attribute value of the time-domain reference point and the reconstructed attribute value of the spatial-domain reference point, where the reconstructed attribute value of the spatial-domain reference point is an updated reconstructed attribute value.

It may be understood that, at the decoding end, according to the method for updating the reconstructed attribute value of the point in the first refinement level as shown in FIG. 11, the reconstructed attribute value of the point in the first refinement level is first updated based on attribute residual values of all points in the current refinement level. Based on this, during determination of the predicted attribute value of each point in the current refinement level, there is no need to update the reconstructed attribute value of the point in the first refinement level again. Instead, one or more first nearest neighboring points of the current point are directly searched for from the at least one first refinement level and the at least one second refinement level, and the predicted attribute value of the current point is determined based on current reconstructed attribute values of spatial-domain reference points among the one or more first nearest neighboring points and the time-domain reference attribute value of the time-domain reference point.

It may be understood that for the same point, the one or more second nearest neighboring points mentioned in the update phase are the same points as the one or more first nearest neighboring points mentioned in the attribute prediction phase. Therefore, in the attribute prediction phase, there is no need to search for the one or more first nearest neighboring points of the current point again; instead, the one or more second nearest neighboring points of the same point found by search during the update phase are directly used as the first nearest neighboring points.

In step 9032, the reconstructed attribute value of the current point is determined based on the predicted attribute value and the attribute residual value of the current point.

In step 9032, the attribute residual value is a dequantized attribute residual value. The point cloud decoder may add the predicted attribute value and the attribute residual value of the current point to obtain the reconstructed attribute value of the current point.

An embodiment of this application provides a PT encoding method. The method includes the following steps 1201 to 1213.

In step 1201, an LOD of the current point cloud is constructed.

Optionally, in some embodiments, the method for the point cloud decoder to construct the LOD of the current point cloud is the same as the foregoing method for the point cloud encoder to construct the LOD of the current point cloud. Specifically, the construction of the LOD may be implemented with reference to the method shown in FIG. 7, and is not repeated here.

In step 1202, a current refinement level is determined, where the current refinement level is a refinement level of the current point in the LOD of the current point cloud.

In step 1203, N first nearest neighboring points of the current point are determined from at least one first refinement level in the LOD of the current point cloud, encoded points in the current refinement level and at least one second refinement level in the LOD of the reference point cloud.

Decoding order of the at least one first refinement level is prior to that of the current refinement level. A predefined distance based on which the second refinement level is generated corresponds to and is equal to a predefined distance based on which the first refinement level is generated. The predefined distance based on which the at least one first refinement level is generated is greater than a predefined distance based on which the current refinement level is generated.

In step 1204, the mapping relationship between attribute values of at least part of points in the current point cloud and reconstructed attribute values of at least part of points in the reference point cloud is fitted, to obtain a weighted prediction parameter, where the weighted prediction parameter includes a weighting factor and/or an offset.

In step 1205, the weighted prediction parameter is written into a bit stream to be transmitted to the point cloud decoder.

Optionally, in some embodiments, the point cloud encoder may write the weighted prediction parameter into a bit stream before writing an attribute residual value of the 1^{st} point in the current point cloud into the bit stream. Subsequently, for the current point cloud, it may no longer write the weighted prediction parameter into the bit stream again.

In step 1206, compensation is performed on a reconstructed attribute value of a time-domain reference point among N first nearest neighboring points of the current point based on the weighted prediction parameter, to obtain the time-domain reference attribute value.

In step 1207, the candidate predicted value of the current point is determined based on a time-domain reference attribute value of a time-domain reference point among the N first nearest neighboring points and a reconstructed attribute value of a spatial-domain reference point among the N first nearest neighboring points.

In step 1208, it is determined that a candidate predicted value with a minimum rate distortion cost among candidate predicted values of the current point is a predicted attribute value of the current point.

In step 1209, a prediction mode of the current point is determined based on an index value of the candidate predicted value with the minimum rate distortion cost among the candidate predicted values of the current point.

In step 1210, a bit stream is generated based on the prediction mode of the current point.

In step 1211, the attribute residual value of the current point is determined based on an attribute value and the predicted attribute value of the current point.

In step 1212, quantization is performed based on the attribute residual value of the current point to obtain a quantized residual.

In step 1213, arithmetic encoding is performed based on the quantized residual of the current point to generate a bit stream.

In step 1214, the quantized residual of the current point is dequantized to obtain a dequantized residual.

In step 1215, the reconstructed attribute value of the current point is determined based on the dequantized residual of the current point and the predicted attribute value of the current point.

An embodiment of this application provides a PT decoding method. The method includes the following steps 1301 to 1311.

In step 1301, an LOD of the current point cloud is constructed.

In step 1302, a current refinement level is determined, where the current refinement level is a refinement level of the current point in the LOD of the current point cloud.

In step 1303, N first nearest neighboring points of the current point are determined from at least one first refinement level in the LOD of the current point cloud, encoded points in the current refinement level and at least one second refinement level in the LOD of the reference point cloud.

Decoding order of the at least one first refinement level is prior to that of the current refinement level. A predefined distance based on which the second refinement level is generated corresponds to and is equal to a predefined distance based on which the first refinement level is generated. The predefined distance based on which the at least one first refinement level is generated is greater than a predefined distance based on which the current refinement level is generated.

In step 1304, a bit stream is decoded to determine a weighted prediction parameter, where the weighted prediction parameter includes a weighting factor and/or an offset.

Optionally, in some embodiments, the weighted prediction parameter is determined by decoding a bit stream before decoding an attribute residual value of the 1^{st} point in the current point cloud.

In step 1305, compensation is performed on a reconstructed attribute value of a time-domain reference point among N first nearest neighboring points of the current point based on the weighted prediction parameter, to obtain the time-domain reference attribute value.

In step 1306, the candidate predicted value of the current point is determined based on a time-domain reference attribute value of a time-domain reference point among the N first nearest neighboring points and a reconstructed attribute value of a spatial-domain reference point among the N first nearest neighboring points.

In step 1307, a bit stream is decoded to determine a prediction mode of the current point.

In step 1308, the predicted attribute value of the current point is determined based on the prediction mode and the candidate predicted value of the current point.

In step 1309, a bit stream is decoded to determine an attribute residual value of the current point.

In step 1310, the quantized residual of the current point is dequantized to obtain a dequantized residual.

In step 1311, the reconstructed attribute value of the current point is determined based on the dequantized residual of the current point and the predicted attribute value of the current point.

An embodiment of this application provides an LT encoding method. The method includes the following steps 1401 to 1413.

In step 1401, an LOD of the current point cloud is constructed.

In step 1402, a current refinement level is determined, where the current refinement level is a refinement level of the current point in the LOD of the current point cloud.

In step 1403, N first nearest neighboring points of the current point are determined from at least one first refinement level of the current point cloud, encoded points in the current refinement level and at least one second refinement level in the LOD of the reference point cloud. Decoding order of the at least one first refinement level is prior to that of the current refinement level. A predefined distance based on which the second refinement level is generated corresponds to and is equal to a predefined distance based on which the first refinement level is generated. The predefined distance based on which the at least one first refinement level is generated is greater than a predefined distance based on which the current refinement level is generated.

In step 1404, the mapping relationship between attribute values of at least part of points in the current point cloud and reconstructed attribute values of at least part of points in the reference point cloud is fitted, to obtain a weighted prediction parameter, where the weighted prediction parameter includes a weighting factor and/or an offset.

In step 1405, the weighted prediction parameter is written into a bit stream to be transmitted to the point cloud decoder.

Optionally, in some embodiments, the point cloud encoder may write the weighted prediction parameter into a bit stream before writing an attribute residual value of the 1st point in the current point cloud into the bit stream. Subsequently, for the current point cloud, it may no longer write the weighted prediction parameter into the bit stream again.

In step 1406, compensation is performed on a reconstructed attribute value of a time-domain reference point among N first nearest neighboring points of the current point based on the weighted prediction parameter, to obtain the time-domain reference attribute value.

In step 1407, the predicted attribute value of the current point is determined based on a weighted average value of a time-domain reference attribute value of a time-domain reference point among the N first nearest neighboring points and a reconstructed attribute value of a spatial-domain reference point among the N first nearest neighboring points.

In step 1408, the attribute residual value of the current point is determined based on an attribute value and the predicted attribute value of the current point.

In step 1409, quantization is performed based on the attribute residual value of the current point to obtain a quantized residual.

In step 1410, arithmetic encoding is performed based on the quantized residual of the current point to generate a bit stream.

In step 1411, the quantized residual of the current point is dequantized to obtain a dequantized residual.

In step 1412, the reconstructed attribute value of the current point is determined based on the dequantized residual of the current point and the predicted attribute value of the current point.

In step 1413, the reconstructed attribute value of the spatial-domain reference point is updated based on the attribute residual value of the current point.

An embodiment of this application provides an LT decoding method. The method includes the following steps 1501 to 1513.

In step 1501, an LOD of the current point cloud is constructed.

In step 1502, a current refinement level is determined, where the current refinement level is a refinement level of the current point in the LOD of the current point cloud.

In step 1503, at least one first refinement layer whose decoding order is prior to that of the current refinement level is determined, where the at least one first refinement level belongs to the LOD of the current point cloud, and a predefined distance based on which the at least one first refinement level is generated is greater than a predefined distance based on which the current refinement level is generated.

In step 1504, a bit stream is decoded to determine an attribute residual value of the current refinement level.

In step 1505, N second nearest neighboring points of an i^{th} point in the current refinement level are determined from the at least one first refinement level and at least one second refinement level in the LOD of the reference point cloud, where i is greater than 0 and less than or equal to a total quantity of points in the current refinement level. A predefined distance based on which the at least one second refinement level is generated corresponds to and is equal to a predefined distance based on which the at least one first refinement level is generated. The predefined distance based on which the at least one first refinement level is generated is greater than a predefined distance based on which the current refinement level is generated.

In step 1506, a reconstructed attribute value of a point belonging to the second refinement level among the one or more second nearest neighboring points is updated based on an attribute residual value of the i^{th} point; and step 1505 and step 1506 are performed for an (i+1)^{th} point until step 1506 is completed for an attribute residual value of the last point in the current refinement level, and then step 1507 is performed.

In step 1507, N first nearest neighboring points of the current point are determined from the at least one first refinement level and at least one second refinement level in the LOD of the reference point cloud.

In step 1508, a bit stream is decoded to determine a weighted prediction parameter.

Optionally, in some embodiments, the weighted prediction parameter is determined by decoding a bit stream before decoding an attribute residual value of the 1st point in the current point cloud.

In step 1509, compensation is performed, based on the weighted prediction parameter, on a reconstructed attribute value of a point (that is, a time-domain reference point) belonging to the reference point cloud among the N first nearest neighboring points, to obtain the time-domain reference attribute value.

In step 1510, the predicted attribute value of the current point is determined based on a weighted average value of the time-domain reference attribute value of the time-domain reference point among the N first nearest neighboring points and a reconstructed attribute value of a spatial-domain reference point among the N first nearest neighboring points.

In step 1511, a bit stream is decoded to determine an attribute residual value of the current point.

In step 1512, the quantized residual of the current point is dequantized to obtain a dequantized residual.

In step 1513, the reconstructed attribute value of the current point is determined based on the dequantized residual of the current point and the predicted attribute value of the current point; steps 1507 to 1513 are performed to determine a reconstructed attribute value of a next point in the current refinement level until a reconstructed attribute value of each point in the current refinement level is obtained, and then step 1502 is performed to determine a reconstructed attribute value of each point in a next refinement level.

An exemplary application of the embodiments of this application in a practical application scenario is described below.

An embodiment of this application provides a GPCC attribute inter prediction optimization and quality enhancement technology based on weighted prediction.

It may be understood that in a current GPCC attribute inter prediction method, there is no compensation operation for a reconstructed attribute value of a neighboring point from a reference point cloud, and fluctuations in attribute average values across different frames is not considered. However, a ratio between attribute average values of neighboring frames of a multi-frame point cloud in a current CTC data set is close to 1, which indicates that the multi-frame point cloud in the CTC data set may be collected in a relatively ideal environment, and an impact of factors such as changes in lighting conditions in a collection environment and a collection process on attributes of the point cloud is not sufficiently taken into consideration. To improve the existing technology, it is necessary to consider how to process point cloud data under different lighting conditions to improve the accuracy and robustness of attribute prediction.

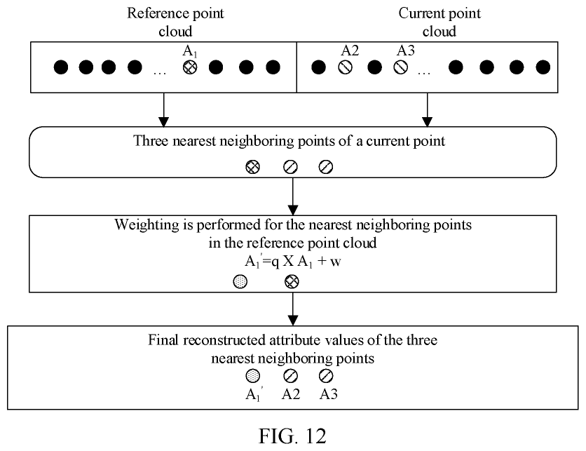

Based on this, in embodiments of this application, a reconstructed attribute value of a neighboring point from a reference point cloud is weighted, and subsequent operations are performed using the weighted reconstructed attribute value. An implementation process of its core method is shown in FIG. 12. Aᵢ (i=1,2,3) is a reconstructed attribute value of three nearest neighboring points of the current point, and a coefficient q, w is a weighted prediction parameter obtained by fitting an attribute value of each point in the current point cloud and a reconstructed attribute value of each point in the reference point cloud, and a reconstructed attribute value of a nearest neighboring point from the reference point cloud is weighted according to q, w, to compensate for a prediction error caused by fluctuations in the inter-frame attribute average value.

Implementation details at the encoding end are described as follows.

### Embodiment 5: Predicting Transform (PT) Encoding of Point Cloud Attribute Information, which Specifically Includes the Following Steps 1 to 4

Step 1: LOD generation, which is the same as the LOD construction process corresponding to FIG. 4 above, which is not repeated here.
Step 2: optimal predicted value selection:

After LOD construction is completed, first, three nearest neighboring points (that is, an example of N first nearest neighboring points) of the current point are found from encoded data points in the current point cloud and the reference point cloud based on generation order of LODs. Compensation is performed on the nearest neighboring point from the reference point cloud in this technical solution. Specific operations are as follows:
1), aᵢ (i=0, 1, . . . , n) is denoted as an attribute value of an i^{th} point in the current point cloud, where n is a quantity of points in the current point cloud. a_refⱼ (j=0, 1, . . . , m) is denoted as a reconstructed attribute value of a j^{th} point in the reference point cloud, where m is a quantity of points in the reference point cloud. q and w may be obtained by fitting according to the following formula (16):

aᵢ=q×a_refᵢ+w (16);
2) q and w are written into a bit stream to be transmitted to the decoding end.
3) Compensation is performed on a reconstructed attribute value ãⱼ (j=0,1,2) of three nearest neighboring points of each point in the current point cloud, j denotes an index of any one of the three nearest neighboring points, and ãⱼ denotes a reconstructed attribute value of a nearest neighboring point j. It is determined whether the nearest neighboring point j is from the reference point cloud. If yes, ãⱼ is weighted to obtain a compensated reconstructed attribute value tempⱼ=q×ãⱼ+w; and if no, tempⱼ=ãⱼ.

Reconstructed attribute values temp; of the three nearest neighboring points are used as candidate predicted values of the current point. Then, an optimal candidate predicted value is selected from the candidate predicted values according to rate-distortion optimal (Rate-Distortion Optimal, RDO) and used as the predicted attribute value of the current point. For example, during encoding of an attribute value of a point P2 in FIG. 4, a reconstructed attribute value temp_{P4} of the nearest neighboring point P4 is used as a candidate predicted value, and an index thereof is set to 1; reconstructed attribute values temp_{P5_ref} and temp_{P0} of the second nearest neighboring point P5_ref (that is, P5_ref is from the reference point cloud) and the third nearest neighboring point P0 are used as candidate predicted values, and indexes thereof are respectively set to 2 and 3; and a weighted average value of reconstructed attribute values temp_{P0}, temp_{P5_ref} and temp_{P4} of P0, P5_ref, and P4 is used as a candidate predicted value, and an index thereof is set to 0, as shown in Table 3. Finally, an optimal candidate predicted value is selected based on an RDO and used as the predicted attribute value of the current point. A formula for the weighted averaging is as shown in the following formula (17):

$${\hat{a}}_{i} = Round ( {\sum }_{j = 0}^{2} \frac{{\tilde{w}}_{ij}}{{\sum }_{j = 0}^{2} {\tilde{w}}_{ij}} {temp}_{j} ) ; \qquad ( 17 )$$

In the formula, \tilde{w}ᵢⱼ represents a spatial geometric weight from the nearest neighboring point j to the current point i. A method for determination is as shown in the following formula (18):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 18 )$$

âᵢ represents a predicted attribute value of the current point i, j represents an index of any one of the three nearest neighboring points, tempⱼ represents a reconstructed attribute value of a nearest neighboring point j, xᵢ, yᵢ, zᵢ are geometric position coordinates of the current point i, and xᵢⱼ, yᵢⱼ, zᵢⱼ are geometric coordinates of the nearest neighboring point j.

TABLE 3
Candidate prediction samples for attribute encoding

| Prediction mode | Candidate predicted value |
|---|---|
| 0 | Weighted average value of reconstructed attribute |
| | values of three nearest neighboring points. |
| 1 | P4 (a reconstructed attribute value of the |
| | first nearest neighboring point) |
| 2 | q × P5_ref + w(a reconstructed attribute |
| | value of the second nearest neighboring point) |
| 3 | P0 (a reconstructed attribute value of the |
| | third nearest neighboring point) |

In Table 3, the so-called first nearest neighboring point refers to the point closest to the current point among the three nearest neighboring points, and the so-called second nearest neighboring point refers to the point second closest to the current point among the three nearest neighboring points, and so on.
Step 3: Attribute prediction residual and quantization:

The predicted attribute value (âᵢ)_{i∈0 . . . k-1} of the current point i is obtained through the foregoing prediction (k is a total quantity of points in the point cloud). If (aᵢ)_{i∈0 . . . k-1} is an original attribute value of the current point, an attribute residual value (rᵢ)_{i∈0 . . . k-1} of the current point i is expressed in the following formula (19):

rᵢ=aᵢ−ãᵢ (19);

Further, the attribute residual value is quantized according to the following formula (20):

$${Q}_{i} = \frac{{r}_{i}}{Q s} ; \qquad ( 20 )$$

In the formula, Qᵢ represents the quantized attribute residual value of the current point i, Qs is a quantization step (Qs), which may be calculated based on a quantization parameter QP (QP) specified by CTC.
Step 4: attribute value reconstruction at the encoding end:

At the encoding end, an attribute value is reconstructed to predict a subsequent point. Before the attribute value is reconstructed, the residual Qᵢ is first dequantized according to the following formula (21), where \hat{r}ᵢ is denoted as a dequantized residual:

\hat{r}ᵢ=Qᵢ×Qs (21);

\hat{r}ᵢ and the predicted attribute value âᵢ are added to obtain the reconstructed attribute value ãᵢ of the point i, as shown in the following formula (22):

ãᵢ=\hat{r}ᵢ+âᵢ (22);

### Embodiment 6: Implementation Details at the Decoding End Corresponding to the PT Encoding End Include the Following Steps 1 to 4

Step 1: LOD generation, which is the same as the LOD construction process corresponding to FIG. 4 above, which is not repeated here.
Step 2: optimal predicted value selection:

After LOD construction is completed, first, three nearest neighboring points of the current point are found from encoded data points in the current point cloud and the reference point cloud based on generation order of LODs. Compensation is performed on the nearest neighboring point from the reference point cloud in this technical solution. Specific operations are as follows:
1) q and w are obtained by parsing a bit stream.
2) Compensation is performed on a reconstructed attribute value ãⱼ (j=0,1,2) of three nearest neighboring points of each point in the current point cloud, j denotes an index of any one of the three nearest neighboring points, and ãⱼ denotes a reconstructed attribute value of a nearest neighboring point j. It is determined whether the nearest neighboring point ãⱼ is from the reference point cloud. If yes, it is weighted to obtain a compensated reconstructed attribute value tempⱼ=q×ãⱼ+w; and if no, tempⱼ=ãⱼ.

Reconstructed attribute values temp; of the three nearest neighboring points and their weighted average value are used as candidate predicted values of the current point. Then, an optimal prediction mode is obtained by parsing the bit stream. The predicted attribute value of the current point is obtained based on the optimal prediction mode, where a method for determining the weighted average is as shown in the formula (23):

$${â}_{i} = Round ( {\sum }_{j = 0}^{2} \frac{{\tilde{w}}_{ij}}{{\sum }_{j - 0}^{2} {\tilde{w}}_{ij}} {temp}_{j} ) ; \qquad ( 23 )$$

In the formula, \tilde{w}ᵢⱼ represents a spatial geometric weight from the nearest neighboring point j to the current point i. A method for determination is as shown in the following formula (24):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 24 )$$

âᵢ represents a predicted attribute value of the current point i, j represents an index of any one of the three nearest neighboring points, temp; represents a reconstructed attribute value of a nearest neighboring point j, xᵢ, yᵢ, zᵢ are geometric position coordinates of the current point i, and xᵢⱼ, yᵢⱼ, zᵢⱼ are geometric coordinates of the nearest neighboring point j.
Step 3: Residual decoding:

An attribute residual value Qᵢ is obtained by parsing the bit stream, and the parsed attribute residual value is dequantized according to the following formula (25), and \hat{r}ᵢ is denoted as a dequantized attribute residual value.

\hat{r}ᵢ=Qᵢ×Qs (25);

Step 4: attribute value reconstruction at the decoding end:

\hat{r}ᵢ and the predicted attribute value âᵢ are added to obtain the reconstructed attribute value ãᵢ of the point i, as shown in the following formula (26):

ãᵢ=\hat{r}ᵢ+ãᵢ (26);

### Embodiment 7: Lifting Transform (LT) Encoding of Point Cloud Attribute Information

FIG. 5 shows a lifting transform encoding process. The lifting transform is also used to perform predictive encoding on attributes of a point cloud based on LODs. A difference from the predicting transform is that the lifting transform first divides the LOD into high and low layers, performs prediction in reverse order of generating LOD layers, and updates quantization weights of points in the low LOD layers by introducing an update operator in the prediction process, thereby improving prediction accuracy. This is because an attribute value of a point in a low LOD layer is frequently used for prediction of an attribute value of a point in a high LOD layer, and the point in the low LOD layer should have greater influence.

In Embodiment 7, the LT encoding process includes the following steps 1 to 3:
Step 1: Partitioning process:

In the partitioning process, the complete LOD layer is divided into a low LOD layer L(N) and a high LOD layer H(N), where a Euclidean distance dₗ based on which L(N) is generated is greater than a Euclidean distance based on which H(N) is generated. If a point cloud has three LODs, that is,

$$LOD = {⋃}_{l = 0}^{3 - 1} {R}_{l} ,$$

$$l = 0 , 1 , 2 ,$$

after the division, (Rₗ)_{l=1,2} is the high LOD layer and is denoted as H(N), and (Rₗ)ₗ₌₀ is the low LOD layer and is denoted as L(N).
Step 2: Prediction process:

For a point in a high LOD layer, attribute information of its nearest neighboring point is selected from a low LOD layer of the current point cloud and the reference point cloud, and based on this, the predicted attribute value P(N) of the current point is determined, and the attribute prediction residual D(N) is as shown in the following formula (27):

D(N)=H(N)−P(N) (27);

Compensation is performed on the neighboring point from the reference point cloud in this technical solution. Specific operations are as follows:
1), aᵢ (i=0, 1, . . . , n) is denoted as an attribute value of an i^{th} point in the current point cloud, where n is a quantity of points in the current point cloud. a_refⱼ (j=0, 1, . . . , m) is denoted as a reconstructed attribute value of a j^{th} point in the reference point cloud, where m is a quantity of points in the reference point cloud. q and w may be obtained by fitting according to the following formula (28):

aᵢ=q×a_refᵢ+W (28);
2) q (that is, a weighting factor) and w (that is, an offset) are written into a bit stream to be transmitted to the decoding end.
3) Compensation is performed on a reconstructed attribute value ãⱼ (j=0, 1, 2) of three nearest neighboring points of each point in the current point cloud, j denotes an index of any one of the three nearest neighboring points, and ãⱼ denotes a reconstructed attribute value of a nearest neighboring point j. It is determined whether the nearest neighboring point j is from the reference point cloud. If yes, ãⱼ is weighted to obtain a compensated reconstructed attribute value tempⱼ=q×ãⱼ+w; and if no, tempⱼ=ãⱼ.
4) Update prediction process: LT encoding differs from PT encoding in that LT encoding has only one prediction mode, that is, a predicted attribute value of the current point is equal to a weighted average value of reconstructed attribute values of three nearest neighboring points, as expressed in the following formula (29):

$${\hat{a}}_{i} = Round ( {\sum }_{j = 0}^{2} \frac{{\tilde{w}}_{ij}}{{\sum }_{j = 0}^{2} {\tilde{w}}_{ij}} {temp}_{j} ) ; \qquad ( 29 )$$

In the formula, \tilde{w}ᵢⱼ represents a spatial geometric weight from the nearest neighboring point j to the current point i. A calculation method is as shown in the following formula (30):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 30 )$$

Step 3: Update process:

An attribute prediction residual D(N) in the high LOD layer is updated, to obtain U(N), and U(N) is used to lift an attribute value of a point in the low LOD layer, as shown in the following formula (31):

L′(N)=L(N)+U(N) (31);

As shown in FIG. 5, the foregoing processes are continuously iterated in descending order of LODs until the lowest LOD layer is processed.

### Embodiment 8: Implementation Details at the Decoding End Corresponding to the LT Encoding End Include the Following Steps 1 to 3

The lifting transform at the decoding end is an inverse process of that at the encoding end. The LOD layers are divided into high layers and low layers, and updating and prediction are sequentially performed from low to high.
Step 1: Partitioning process:

In the partitioning process, the complete LOD layer is divided into a low LOD layer L(N) and a high LOD layer H(N), where a Euclidean distance dₗ based on which L(N) is generated is greater than a Euclidean distance based on which H(N) is generated. If a point cloud has three LODs, that is,

$$LOD = {⋃}_{l = 0}^{3 - 1} {R}_{l} ,$$

$$l = 0 , 1 , 2 ,$$

after the division, (Rₗ)_{l=1,1} is the high LOD layer and is denoted as H(N), and (Rₗ)ₗ₌₀ is the low LOD layer and is denoted as L(N).
Step 2: Update process:

First, a residual D(N) is obtained by parsing a bit stream, and is then dequantized, and the dequantized D(N) is updated to obtain U(N). The reconstructed attribute value of the point in the low LOD layer is updated by using U(N), as shown in the formula (32):

R′₀(N)=R₀(N)−U(N) (32);
Step 3: Prediction process:

For a point in R₁(N), attribute information of its nearest neighboring point is selected from

$${R}_{0}^{′} ( N )$$

of the current point cloud and the reference point cloud and used as a predicted attribute value P(N) of the current point to obtain a reconstructed attribute value R₁(N), as shown in the following formula (33):

R(N)=D(N)+P(N) (33);

Compensation is performed on the nearest neighboring point from the reference point cloud in this technical solution. Specific operations are as follows:
1) q and w are obtained by parsing a bit stream.
2) Compensation is performed on a reconstructed attribute value ãⱼ (j=0,1,2) of three nearest neighboring points of each point in the current point cloud, j denotes an index of any one of the three nearest neighboring points, and ãⱼ denotes a reconstructed attribute value of a nearest neighboring point j. It is determined whether the nearest neighboring point j is from the reference point cloud. If yes, ãⱼ is weighted to obtain a compensated reconstructed attribute value tempⱼ=q×ãⱼ+w; and if no, tempⱼ=ãj.

The reconstructed attribute values temp; of the three nearest neighboring points is weighted to obtain a predicted attribute value. A formula for the weighted averaging is as shown in the following formula (34):

$${\hat{a}}_{i} = Round ( {\sum }_{j = 0}^{2} \frac{{\tilde{w}}_{ij}}{{\sum }_{j = 0}^{2} {\tilde{w}}_{ij}} {temp}_{j} ) ; \qquad ( 34 )$$

In the formula, \tilde{w}ᵢⱼ represents a spatial geometric weight from the nearest neighboring point j to the current point i. A calculation method is as shown in the following formula (35):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} ; \qquad ( 35 )$$

âᵢ represents a predicted attribute value of the current point i, j represents an index of any one of the three nearest neighboring points, temp; represents a reconstructed attribute value of a nearest neighboring point j, xᵢ, yᵢ, zᵢ are geometric position coordinates of the current point i, and xᵢⱼ, yᵢⱼ, zᵢⱼ are geometric coordinates of the nearest neighboring point j.

The foregoing processes are continuously iterated in ascending order of LODs until the highest LOD layer is processed.

Since an average attribute of frames of each sequence in all seven point cloud sequences of the Cat3 data set specified by the CTC is almost the same, the effectiveness of this technical solution cannot be verified, nor can the shortcomings of the existing technical solution be reflected. Therefore, in this technical solution, the reflectance of each frame of point cloud is randomly linearly weighted based on the Cat3 data set to obtain a modified data set. A specific operation method is as follows: The ford_01 sequence is used as an example. In this case, 32 consecutive point cloud frames are randomly extracted from an original point cloud sequence, and a random number is added to original reflectance of each frame of point cloud, and no any other information is changed, to obtain a modified point cloud. The same applies to the other six point cloud sequences.

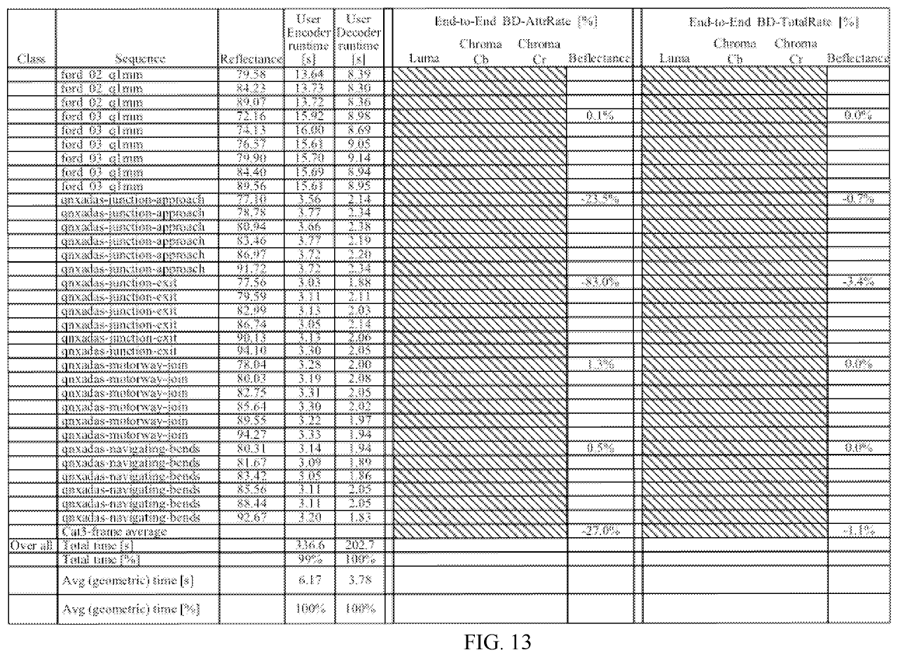

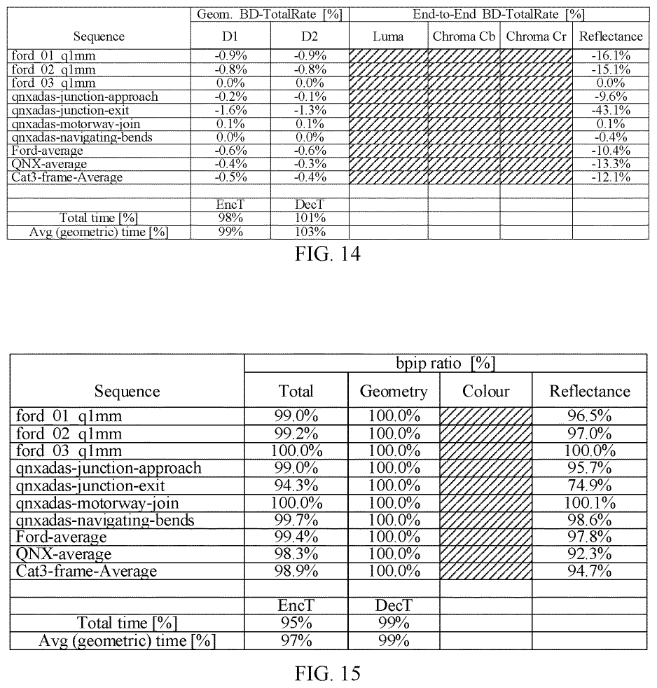

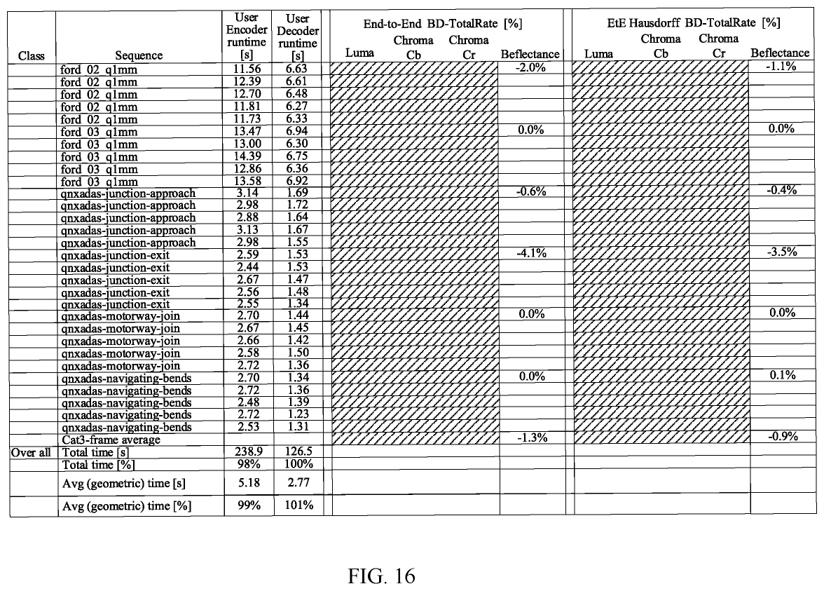

After the proposed technical solution is implemented on the G-PCC reference software TMC13 V23-rc1, tests are carried out under the CTC-C1/C2/CW/CY test conditions. The test results are shown in FIG. 13 to FIG. 16. It can be seen that the technical solution has gains under all test conditions of the CTC, and the time complexity remains unchanged or slightly reduced. Under the C1/C2/CW/CY test conditions, gains of −1.1%, −12.1%, 94.7%, and −1.3% can be obtained, respectively.

The C1 condition is lossless geometry, lossy attribute encoding mode (lossless geometry, lossy attribute), the C2 condition is lossy geometry, lossy attribute encoding mode (lossy geometry, lossy attribute), the CW condition is lossless geometry, lossless attribute encoding mode (lossless geometry, lossless attribute), and the CY condition is lossless geometry, nearlossless attribute encoding mode (lossless geometry, nearlossless attribute). In the figures, End-to-End BD-AttrRate represents a BD-Rate of end-to-end attribute values for an attribute bit stream, End-to-End BD-TotalRate represents a BD-Rate of end-to-end attribute values for a total bit stream, and Geom, and End-to-End BD-TotalRate represents a BD-Rate of end-to-end geometry for a total bit stream. BD-Rate reflects a difference in PSNR curves between the two cases. When BD-Rate decreases, it means that under the condition of equal PSNR, a bit rate decreases and performance is improved; and otherwise, performance decreases. In other words, a larger decrease in the BD-Rate indicates a better compression effect. BPIP represents a quantity of bits required to be consumed per input point, D1 and D2 represent geometric distortion, the former being point-to-point distortion and the latter being point-to-plane distortion. Cat3-frame average represents an average value of test results of point cloud sequences in each data set.

It may be understood that, in this solution, a GPCC attribute inter prediction optimization and quality enhancement technology based on weighted prediction is proposed, effectively solving prediction inaccuracy caused by reflectance fluctuations in multi-frame point cloud data sets. By fitting a linear relationship between attributes of the current point cloud and the reference point cloud, and weighting a reconstructed attribute value of a nearest neighboring point in the reference point cloud based on the linear relationship, encoding efficiency is improved, and quality enhancement of the point cloud reconstructed at the decoding end is implemented.

It should be noted that although the various steps of the methods in this application are described in specific order in the accompanying drawings, this does not require or imply that these steps must be performed in the specific order, or that all the steps shown must be performed to achieve desired results. Additionally or alternatively, some steps may be omitted, a plurality of steps may be combined into one step for execution, and/or one step may be decomposed into a plurality of steps for execution, and so on. Alternatively, steps from different embodiments may be combined into a new technical solution.

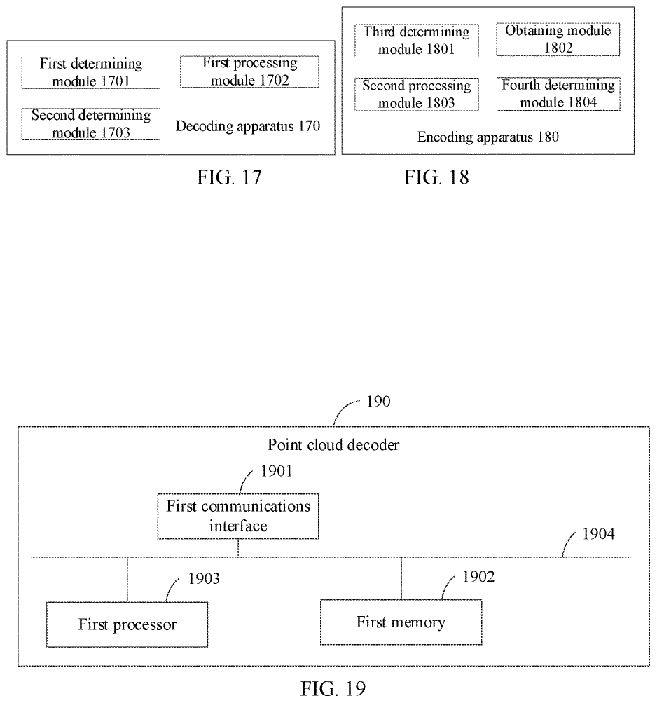

Based on the foregoing embodiments, an embodiment of this application provides a decoding apparatus, applied to a point cloud decoder. FIG. 17 is a schematic structural diagram of the decoding apparatus according to the embodiment of this application. As shown in FIG. 17, the decoding apparatus 170 includes:
a first determining module 1701 configured to determine, based on geometric information of a current point cloud, a reference point of a current point in the current point cloud, where the reference point includes a time-domain reference point, the time-domain reference point is one or more points in a reference point cloud, and the reference point cloud is point cloud data that has been decoded before decoding the current point cloud;
a first processing module 1702, configured to process an attribute value of the time-domain reference point based on a weighted prediction parameter, to obtain a time-domain reference attribute value, where the weighted prediction parameter is obtained by decoding a bit stream; and
a second determining module 1703, configured to determine a reconstructed attribute value of the current point based on the time-domain reference attribute value of the time-domain reference point.

In some embodiments, the weighted prediction parameter is used to represent a mapping relationship between attribute values of at least part of points in the current point cloud and reconstructed attribute values of at least part of points in the reference point cloud.

In some embodiments, the weighted prediction parameter is a fitting coefficient obtained by fitting the mapping relationship between attribute values of at least part of points in the current point cloud and reconstructed attribute values of at least part of points in the reference point cloud.

In some embodiments, the weighted prediction parameter includes a weighting factor and/or an offset.

In some embodiments, the weighted prediction parameter is determined by decoding a bit stream before decoding an attribute residual value of the 1^{st} point in the current point cloud.

In some embodiments, the processing the attribute value of the time-domain reference point based on the weighted prediction parameter, to obtain the time-domain reference attribute value includes: determining a first product of the weighting factor and a reconstructed attribute value of the time-domain reference point; and offsetting the first product based on the offset, to obtain the time-domain reference attribute value.

In some embodiments, the determining, based on the geometric information of the current point cloud, the reference point of the current point in the current point cloud includes: determining a current refinement level, where the current refinement level is a refinement level of the current point in an LOD of the current point cloud; and determining the reference point of the current point from at least one first refinement level in the LOD of the current point cloud, decoded points in the current refinement level and/or at least one second refinement level in an LOD of the reference point cloud, where decoding order of the at least one first refinement level is prior to that of the current refinement level, and a predefined distance based on which the second refinement level is generated corresponds to and is equal to a predefined distance based on which the first refinement level is generated.

In some embodiments, a predefined distance based on which the at least one first refinement level is generated is greater than a predefined distance based on which the current refinement level is generated.

In some embodiments, the reference point is one or more first nearest neighboring points of the current point, and the one or more first nearest neighboring points are from the current point cloud and/or the reference point cloud.

In some embodiments, the decoding apparatus 170 further includes a decoding module, where the decoding module is configured to decode a bit stream to obtain an attribute residual value of the current point. The determining the reconstructed attribute value of the current point based on the time-domain reference attribute value of the time-domain reference point includes: determining a predicted attribute value of the current point based on the time-domain reference attribute value of the time-domain reference point; and determining the reconstructed attribute value of the current point based on the predicted attribute value and the attribute residual value of the current point.

In some embodiments, a process of constructing an LOD of the current point cloud includes: obtaining L predefined distances, where L is greater than 1; marking all points in the current point cloud as unvisited, and setting a visited point set to an empty set; performing a first process based on an l^{th} predefined distance, where l is greater than or equal to 0 and less than or equal to L, and the first process includes: traversing all points, and if the current point has been visited, ignoring it, or if the current point has not been visited, determining a minimum distance between the current point and a point in the visited point set; and if the minimum distance is less than the l^{th} predefined distance, ignoring the current point; or if the minimum distance is greater than or equal to the l^{th} predefined distance, marking the current point as visited, and adding the current point to an l^{th} refinement level and the visited point set; and performing the first process based on an (l+1)^{th} predefined distance until an L^{th} refinement level corresponding to an L^{th} predefined distance, and obtaining a union of refinement levels respectively corresponding to the L predefined distances, to obtain the LOD of the current point cloud.

In some embodiments, the determining the predicted attribute value of the current point based on the time-domain reference attribute value of the time-domain reference point includes: determining a candidate predicted value of the current point based on the time-domain reference attribute value of the time-domain reference point; decoding a bit stream to determine a prediction mode of the current point; and determining the predicted attribute value of the current point based on the prediction mode and the candidate predicted value of the current point.

In some embodiments, the reference point further includes a spatial-domain reference point, where the spatial-domain reference point is one or more decoded points in the current point cloud. The determining the candidate predicted value of the current point based on the time-domain reference attribute value of the time-domain reference point includes: determining the candidate predicted value of the current point based on the time-domain reference attribute value of the time-domain reference point and a reconstructed attribute value of the spatial-domain reference point.

In some embodiments, the candidate predicted value of the current point includes the time-domain reference attribute value of the time-domain reference point, a weighted average value of the time-domain reference attribute value of the time-domain reference point, and the reconstructed attribute value of the spatial-domain reference point and/or a weighted average value of the time-domain reference attribute value of the time-domain reference point and the reconstructed attribute value of the spatial-domain reference point.

In some embodiments, the predicted attribute value of the current point is equal to a candidate predicted value corresponding to the prediction mode.

In some embodiments, the reference point further includes a spatial-domain reference point, where the spatial-domain reference point is one or more decoded points in the current point cloud. The determining the predicted attribute value of the current point based on the time-domain reference attribute value of the time-domain reference point includes: determining the predicted attribute value of the current point based on the time-domain reference attribute value of the time-domain reference point and a reconstructed attribute value of the spatial-domain reference point.

In some embodiments, the determining the predicted attribute value of the current point based on the time-domain reference attribute value of the time-domain reference point and a reconstructed attribute value of the spatial-domain reference point includes: determining the predicted attribute value of the current point based on a weighted average value of the time-domain reference attribute value of the time-domain reference point and the reconstructed attribute value of the spatial-domain reference point.

In some embodiments, the predicted attribute value of the current point is equal to the weighted average value.

In some embodiments, the decoding apparatus 170 further includes a first updating module, configured to: before determining the predicted attribute value of the current point based on the time-domain reference attribute value of the time-domain reference point and the reconstructed attribute value of the spatial-domain reference point, update a reconstructed attribute value of a point in the at least one first refinement level based on an attribute residual value of a point in the current refinement level.

In some embodiments, the updating the reconstructed attribute value of the point in the at least one first refinement level based on the attribute residual value of the point in the current refinement level includes: performing a second process based on an i^{th} point in the current refinement level, where the second process includes: determining one or more second nearest neighboring points of the i^{th} point in the current refinement level from the at least one first refinement level and the at least one second refinement level in the LOD of the reference point cloud, where i is greater than 0 and less than or equal to a total quantity of points in the current refinement level; updating, based on an attribute residual value of the i^{th} point, a reconstructed attribute value of a point belonging to the first refinement level among the one or more second nearest neighboring points; and iterating the second process based on an (i+1)^{th} point in the current refinement level, until the second process is performed based on the last point in the current refinement level.

In some embodiments, the at least one first refinement level includes a refinement level generated based on a maximum distance in the LOD of the current point cloud, and an initial reconstructed attribute value of a point in the refinement level generated based on the maximum distance is equal to a first numerical value.

The description of the above decoding apparatus embodiments is similar to the description of the above decoding method embodiments, and the decoding apparatus embodiments have similar beneficial effects as the decoding method embodiments. For technical details not disclosed in the decoding apparatus embodiments of this application, reference is made to the description of the decoding method embodiments of this application for understanding.

Based on the foregoing embodiments, an embodiment of this application provides an encoding apparatus, applied to a point cloud encoder. FIG. 18 is a schematic structural diagram of an encoding apparatus according to an embodiment of this application. As shown in FIG. 18, the encoding apparatus 180 includes: a third determining module 1801, configured to determine, based on geometric information of a current point cloud, a reference point of a current point in the current point cloud, where the reference point includes a time-domain reference point, the time-domain reference point is one or more points in a reference point cloud, and the reference point cloud is point cloud data that has been decoded before decoding the current point cloud; an obtaining module 1802, configured to obtain a weighted prediction parameter, where the weighted prediction parameter is determined based on attribute values of at least part of points in the current point cloud and reconstructed attribute values of at least part of points in the reference point cloud; a second processing module 1803, configured to process an attribute value of the time-domain reference point based on the weighted prediction parameter, to obtain a time-domain reference attribute value; and a fourth determining module 1804, configured to determine an attribute residual value of the current point based on the time-domain reference attribute value of the time-domain reference point.

In some embodiments, the encoding apparatus 180 further includes an encoding module, configured to generate a bit stream based on the weighted prediction parameter.

In some embodiments, the generating the bit stream based on the weighted prediction parameter includes: writing the weighted prediction parameter into the bit stream before writing an attribute residual value of the 1^{st} point in the current point cloud into the bit stream.

In some embodiments, the weighted prediction parameter is used to represent a mapping relationship between attribute values of at least part of points in the current point cloud and reconstructed attribute values of at least part of points in the reference point cloud.

In some embodiments, the weighted prediction parameter is a fitting coefficient obtained by fitting the mapping relationship between attribute values of at least part of points in the current point cloud and reconstructed attribute values of at least part of points in the reference point cloud.

In some embodiments, the weighted prediction parameter includes a weighting factor and/or an offset.

In some embodiments, the processing the attribute value of the time-domain reference point based on the weighted prediction parameter, to obtain the time-domain reference attribute value includes: determining a first product of the weighting factor and a reconstructed attribute value of the time-domain reference point; and offsetting the first product based on the offset, to obtain the time-domain reference attribute value.

In some embodiments, the determining, based on the geometric information of the current point cloud, the reference point of the current point in the current point cloud includes: determining a current refinement level, where the current refinement level is a refinement level of the current point in an LOD of the current point cloud; and determining the reference point of the current point from at least one first refinement level in the LOD of the current point cloud, encoded points in the current refinement level and/or at least one second refinement level in an LOD of the reference point cloud, where encoding order of the at least one first refinement level is prior to that of the current refinement level, and a predefined distance based on which the second refinement level is generated corresponds to and is equal to a predefined distance based on which the first refinement level is generated.

In some embodiments, a predefined distance based on which the at least one first refinement level is generated is greater than a predefined distance based on which the current refinement level is generated.

In some embodiments, the reference point is one or more first nearest neighboring points of the current point, and the one or more first nearest neighboring points are from the current point cloud and/or the reference point cloud.

In some embodiments, the determining the attribute residual value of the current point based on the time-domain reference attribute value of the time-domain reference point includes: determining a predicted attribute value of the current point based on the time-domain reference attribute value of the time-domain reference point; and determining the attribute residual value of the current point based on an attribute value and the predicted attribute value of the current point.

In some embodiments, the encoding module is further configured to generate a bit stream based on the attribute residual value of the current point.

In some embodiments, the determining the predicted attribute value of the current point based on the time-domain reference attribute value of the time-domain reference point includes: determining a candidate predicted value of the current point based on the time-domain reference attribute value of the time-domain reference point; and determining the predicted attribute value of the current point based on a rate distortion cost of the candidate predicted value of the current point.

In some embodiments, the reference point further includes a spatial-domain reference point, where the spatial-domain reference point is one or more encoded points in the current point cloud. The determining the candidate predicted value of the current point based on the time-domain reference attribute value of the time-domain reference point includes: determining the candidate predicted value of the current point based on the time-domain reference attribute value of the time-domain reference point and a reconstructed attribute value of the spatial-domain reference point.

In some embodiments, the candidate predicted value of the current point includes the time-domain reference attribute value of the time-domain reference point, a weighted average value of the time-domain reference attribute value of the time-domain reference point, and the reconstructed attribute value of the spatial-domain reference point and/or a weighted average value of the time-domain reference attribute value of the time-domain reference point and the reconstructed attribute value of the spatial-domain reference point.

In some embodiments, the predicted attribute value of the current point is equal to the candidate predicted value with the minimum rate distortion cost.

In some embodiments, the fourth determining module 1804 is further configured to determine a prediction mode of the current point based on an index value of the candidate predicted value with the minimum rate distortion cost among candidate predicted values of the current point. The encoding module is further configured to generate a bit stream based on the prediction mode.

In some embodiments, the reference point further includes a spatial-domain reference point, where the spatial-domain reference point is one or more encoded points in the current point cloud. The determining the predicted attribute value of the current point based on the time-domain reference attribute value of the time-domain reference point includes: determining the predicted attribute value of the current point based on the time-domain reference attribute value of the time-domain reference point and a reconstructed attribute value of the spatial-domain reference point.

In some embodiments, the determining the predicted attribute value of the current point based on the time-domain reference attribute value of the time-domain reference point and a reconstructed attribute value of the spatial-domain reference point includes: determining the predicted attribute value of the current point based on a weighted average value of the time-domain reference attribute value of the time-domain reference point and the reconstructed attribute value of the spatial-domain reference point.

In some embodiments, the predicted attribute value of the current point is equal to the weighted average value.

In some embodiments, the encoding apparatus 180 further includes a second updating module, configured to: after determining the attribute residual value of the current point, update the reconstructed attribute value of the spatial-domain reference point based on the attribute residual value of the current point.

The description of the above encoding apparatus embodiments is similar to the description of the above encoding method embodiments, and the encoding apparatus embodiments have similar beneficial effects as the encoding method embodiments. For technical details not disclosed in the encoding apparatus embodiments of this application, reference is made to the descriptions of the encoding method embodiments of this application for understanding.

It should be noted that the division of modules in the apparatus described in embodiments of this application is schematic, and is merely logical function division. There may be other division manners in actual implementation. In addition, functional units in embodiments of this application may be integrated into one processing unit, or each of the units may exist alone physically, or two or more units may be integrated into one unit. The integrated unit may be implemented in a form of hardware, or may be implemented in a form of a software functional unit. It may alternatively be implemented in a combination of software and hardware.

It should be noted that, in embodiments of this application, if the foregoing method are implemented in the form of a software functional module and sold or used as an independent product, it may also be stored in a computer-readable storage medium. Based on such an understanding, the technical solutions of embodiments of this application essentially, or the part that contributes to the related technology, may be implemented in a form of a software product. The computer software product is stored in a storage medium and includes several instructions for causing an electronic device to execute all or part of the methods described in the various embodiments of this application. The foregoing storage medium includes various media that can store program codes, such as a USB flash drive, a removable hard disk, a read-only memory (ROM), a magnetic disk, or an optical disc. In this way, the embodiments of this application are not limited to any specific combination of hardware and software.

An embodiment of this application provides a computer-readable storage medium, where the computer-readable storage medium stores a computer program, and the computer program, when executed, causes the encoding method on the point cloud encoder side, or the decoding method on the point cloud decoder side to be implemented.

An embodiment of this application provides a point cloud decoder. As shown in FIG. 19, a point cloud decoder 190 includes: a first communications interface 1901, a first memory 1902, and a first processor 1903. The components are coupled together by using a first bus system 1904. It may be understood that the first bus system 1904 is configured to implement connection and communication between these components. The first bus system 1904 may further include a power bus, a control bus, a status signal bus, and the like, in addition to a data bus. However, for clarity of description, various buses are marked as the first bus system 1904 in FIG. 19.

The first communications interface 1901 is configured to receive and transmit signals in the process of transmitting and receiving information with other external network elements.

The first memory 1902 is configured to store a computer program runnable on the first processor 1903.

The first processor 1903 is configured to run the computer program to perform the decoding method according to embodiments of this application.

It may be understood that, in embodiments of this application, the first memory 1902 may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct Rambus random access memory (DRRAM). The first memory 1902 in the systems and the methods described in this application include but are not limited to these and any memory of another appropriate type.

However, the first processor 1903 may be an integrated circuit chip and has a signal processing capability. In an implementation process, steps in the foregoing method can be implemented by using a hardware integrated logical circuit in the first processor 1903, or by using instructions in a form of software. The first processor 1903 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The methods, the steps, and logical block diagrams that are disclosed in embodiments of this application may be implemented or performed. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, such as a random access memory, a flash memory, a read-only memory, a programmable read-only memory, an electrically erasable programmable memory, or a register. The storage medium is located in the first memory 1902, and the first processor 1903 reads information in the first memory 1902 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (ASIC), digital signal processors (DSP), digital signal processing devices (DSPD), programmable logic devices (PLD), field programmable gate arrays (FPGA), general-purpose processors, controllers, microcontrollers, microprocessors, and other electronic units configured to perform the functions described in this application, or a combination thereof. For software implementation, the techniques described in this application can be implemented by modules (e.g., processes, functions, etc.) that perform the functions described in this application. Software code may be stored in a memory and executed by a processor. The memory can be implemented in or outside the processor.

Optionally, in another embodiment, the first processor 1903 is further configured to run the computer program to execute any one of the foregoing decoding method embodiments.

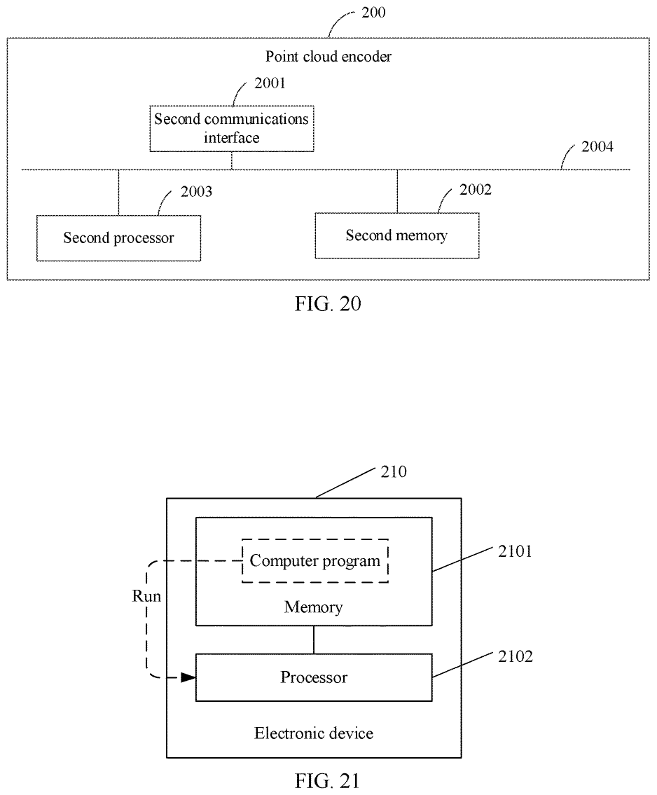

An embodiment of this application provides a point cloud encoder. As shown in FIG. 20, the point cloud encoder 200 includes a second communications interface 2001, a second memory 2002, and a second processor 2003. The components are coupled together through a second bus system 2004. It may be understood that the second bus system 2004 is configured to implement connection and communication between these components. The second bus system 2004 may further include a power bus, a control bus, a status signal bus, and the like, in addition to a data bus. However, for clarity of description, various buses are all marked as the second bus system 2004 in FIG. 20.

The second communications interface 2001 is configured to receive and transmit a signal in a process of transmitting and receiving information between the second communications interface and another external network element.

The second memory 2002 is configured to store a computer program runnable on the second processor 2003.

The second processor 2003 is configured to run the computer program to perform the encoding method according to embodiments of this application.

Optionally, in another embodiment, the second processor 2003 is further configured to run the computer program to execute any one of the foregoing encoding method embodiments.

It may be understood that hardware functions of the second memory 2002 are similar to those of the first memory 1902, and hardware functions of the second processor 2003 are similar to those of the first processor 1903, which is not detailed here.

An embodiment of this application provides an electronic device. FIG. 21 is a schematic structural diagram of an electronic device according to an embodiment of this application. As shown in FIG. 21, the electronic device 210 includes a memory 2101 and a processor 2102. The memory 2101 stores a computer program that can run on the processor 2102, and the program, when executed by the processor 2102, causes the steps of the methods provided in the foregoing embodiments to be implemented.

It should be noted that the memory 2101 is configured to store instructions and applications executable by the processor 2102, and may further cache data to be processed or already processed by the processor 2102 and various modules in the electronic device 210 (for example, image data, audio data, voice communication data, and video communication data), and may be implemented by using a flash memory (FLASH) or a random access memory (RAM).

An embodiment of this application provides a computer-readable storage medium, where the computer-readable storage medium stores a computer program, and the computer program, when executed by a processor, causes steps of the methods provided in the foregoing embodiments to be implemented.

An embodiment of this application provides a computer program product that includes instructions, and the instructions, when executed on a computer, causes the computer to execute the steps of the methods provided in the foregoing method embodiments.

It should be noted herein that, the description of the foregoing storage medium and device embodiments is similar to the description of the foregoing method embodiments, and the storage medium and device embodiments have similar beneficial effects as the method embodiments. For technical details not disclosed in the storage medium, storage medium and device embodiments of this application, reference is made to the description of the method embodiments of this application.

It should be understood that, “one embodiment” or “an embodiment” or “some embodiments” throughout this specification means that specific features, structures or characteristics related to the embodiments may be included in at least one embodiment of this application. Therefore, the expression “in an embodiment” or “in one embodiments” or “in some embodiments” appearing throughout the specification do not necessarily refer to the same embodiment. In addition, these specific features, structures, or characteristics may be combined in one or more embodiments in any appropriate manner. It should be understood that, in embodiments of this application, sequence numbers of the foregoing processes do not mean execution sequences. The execution sequences of the processes should be determined based on functions and internal logic of the processes, and should not be construed as any limitation on the implementation processes of the embodiments of this application. The foregoing sequence numbers of embodiments of this application are merely described, and do not represent advantages or disadvantages of the embodiments. The foregoing descriptions of the various embodiments tend to emphasize differences between the embodiments, and similarities or common features thereof may be referred to each other. For brevity, details are not repeated herein.

In this specification, the term “and/or” is merely an association relationship that describes associated objects, and represents that there may be three relationships. For example, an object A and/or an object B may represent three cases: only the object A exists, both the object A and the object B exist, and only the object B exists.

It should be noted that in this application, the term “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or device. In the absence of further restrictions, the element limited by the sentence “including a . . . ” does not exclude the existence of other identical elements in the process, method, item or device including this element.

In several embodiments provided in this application, it should be understood that the disclosed device and method may be implemented in another manner. The described embodiments are merely examples. For example, the module division is merely logical function division and may be other division in actual implementation. For example, a plurality of modules or components may be combined or integrated into another system, or some features may be ignored or not executed. In addition, the displayed or discussed mutual couplings or direct couplings or communication connections between the component parts may be implemented as indirect couplings or communication connections through some interfaces, devices or modules, and may be implemented in electrical, mechanical, or other forms.

The modules described as separate parts may be or may not be physically separate, and parts displayed as modules may be or may not be physical modules, and may be at one place, or may be distributed on a plurality of network units. Some or all of the modules may be selected according to actual needs to achieve the objectives of the embodiments.

In addition, functional modules in embodiments of this application may be all integrated into one processing unit, or each of the modules may exist alone as a separate unit, or two or more modules may be integrated into one unit. The foregoing integrated modules may be implemented in the form of hardware or in the form of hardware and software functional units.

A person of ordinary skill in the art may understand that all or part of the steps of the above method embodiments may be implemented by hardware related to program instructions. The above program may be stored in a computer-readable storage medium. The program, when executed, causes the steps of the above method embodiments to be performed. The foregoing storage medium includes: a removable storage device, a read-only memory (ROM), a magnetic disk, an optical disk, or other media that can store program code.

Alternatively, if the above integrated unit of this application is implemented in the form of a software functional module and sold or used as an independent product, it may be stored in a computer-readable storage medium. Based on such an understanding, the technical solutions of embodiments of this application essentially, or the part that contributes to the related technology, may be implemented in a form of a software product. The computer software product is stored in a storage medium and includes several instructions for causing an electronic device to execute all or part of the methods described in the various embodiments of this application. The foregoing storage medium includes: a removable storage device, a ROM, a magnetic disk, an optical disc, or other media that can store program code.

The disclosed methods provided in the several method embodiments of this application may be randomly combined with each other in the case of no conflicts, to obtain new method embodiments. The disclosed features provided in the several product embodiments of this application may be randomly combined with each other in the case of no conflicts, to obtain new product embodiments. The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A decoding method, wherein the method is applied to a point cloud decoder, and the method comprises:
determining, based on geometric information of a current point cloud, a reference point of a current point in the current point cloud, wherein the reference point comprises a time-domain reference point, the time-domain reference point is one or more points in a reference point cloud, and the reference point cloud is point cloud data that has been decoded before decoding the current point cloud;
processing an attribute value of the time-domain reference point based on a weighted prediction parameter, to obtain a time-domain reference attribute value, wherein the weighted prediction parameter is obtained by decoding a bit stream; and
determining a reconstructed attribute value of the current point based on the time-domain reference attribute value of the time-domain reference point.

2. The method according to claim 1, wherein the weighted prediction parameter is used to represent a mapping relationship between attribute values of at least part of points in the current point cloud and reconstructed attribute values of at least part of points in the reference point cloud.

3. The method according to claim 2, wherein the weighted prediction parameter is a fitting coefficient obtained by fitting the mapping relationship between attribute values of at least part of points in the current point cloud and reconstructed attribute values of at least part of points in the reference point cloud.

4. The method according to claim 3, wherein the weighted prediction parameter comprises a weighting factor and/or an offset.

5. The method according to claim 1, wherein the weighted prediction parameter is determined by decoding a bit stream before decoding an attribute residual value of a 1^{st} point in the current point cloud.

6. The method according to claim 4, wherein the processing the attribute value of the time-domain reference point based on the weighted prediction parameter, to obtain the time-domain reference attribute value comprises:
determining a first product of the weighting factor and a reconstructed attribute value of the time-domain reference point; and
offsetting the first product based on the offset, to obtain the time-domain reference attribute value.

7. The method according to claim 1, wherein the determining, based on the geometric information of the current point cloud, the reference point of the current point in the current point cloud comprises:
determining a current refinement level, wherein the current refinement level is a refinement level of the current point in a level of detail (LOD) of the current point cloud; and
determining the reference point of the current point from at least one first refinement level in the LOD of the current point cloud, decoded points in the current refinement level and/or at least one second refinement level in an LOD of the reference point cloud, wherein decoding order of the at least one first refinement level is prior to that of the current refinement level, and a predefined distance based on which the second refinement level is generated corresponds to and is equal to a predefined distance based on which the first refinement level is generated.

8. The method according to claim 7, wherein a predefined distance based on which the at least one first refinement level is generated is greater than a predefined distance based on which the current refinement level is generated.

9. The method according to claim 7, wherein the reference point is one or more first nearest neighboring points of the current point, and the one or more first nearest neighboring points are from the current point cloud and/or the reference point cloud.

10. The method according to claim 7, wherein the method further comprises: decoding a bit stream to obtain an attribute residual value of the current point; and
the determining the reconstructed attribute value of the current point based on the time-domain reference attribute value of the time-domain reference point comprises:
determining a predicted attribute value of the current point based on the time-domain reference attribute value of the time-domain reference point; and
determining the reconstructed attribute value of the current point based on the predicted attribute value and the attribute residual value of the current point.

11. The method according to claim 7, wherein a process of constructing an LOD of the current point cloud comprises:
obtaining L predefined distances, wherein L is greater than 1;
marking all points in the current point cloud as unvisited, and setting a visited point set to an empty set;
performing a first process based on an l^{th} predefined distance, wherein l is greater than or equal to 0 and less than or equal to L, and the first process comprises: traversing all points, and if the current point has been visited, ignoring it, or if the current point has not been visited, determining a minimum distance between the current point and a point in the visited point set; and if the minimum distance is less than the l^{th} predefined distance, ignoring the current point; or if the minimum distance is greater than or equal to the l^{th} predefined distance, marking the current point as visited, and adding the current point to an l^{th} refinement level and the visited point set; and
performing the first process based on an (l+1)^{th} predefined distance until an L^{th} refinement level corresponding to an L^{th} predefined distance, and obtaining a union of refinement levels respectively corresponding to the L predefined distances, to obtain the LOD of the current point cloud.

12. The method according to claim 10, wherein the determining the predicted attribute value of the current point based on the time-domain reference attribute value of the time-domain reference point comprises:
determining a candidate predicted value of the current point based on the time-domain reference attribute value of the time-domain reference point;
decoding a bit stream to determine a prediction mode of the current point; and
determining the predicted attribute value of the current point based on the prediction mode and the candidate predicted value of the current point.

13. The method according to claim 12, wherein the reference point further comprises a spatial-domain reference point, and the spatial-domain reference point is one or more decoded points in the current point cloud; and
the determining the candidate predicted value of the current point based on the time-domain reference attribute value of the time-domain reference point comprises:
determining the candidate predicted value of the current point based on the time-domain reference attribute value of the time-domain reference point and a reconstructed attribute value of the spatial-domain reference point.

14. The method according to claim 12, wherein the candidate predicted value of the current point comprises the time-domain reference attribute value of the time-domain reference point, a weighted average value of the time-domain reference attribute value of the time-domain reference point, and the reconstructed attribute value of the spatial-domain reference point and/or a weighted average value of the time-domain reference attribute value of the time-domain reference point and the reconstructed attribute value of the spatial-domain reference point.

15. The method according to claim 10, wherein the reference point further comprises a spatial-domain reference point, and the spatial-domain reference point is one or more decoded points in the current point cloud; and
the determining the predicted attribute value of the current point based on the time-domain reference attribute value of the time-domain reference point comprises:
determining the predicted attribute value of the current point based on the time-domain reference attribute value of the time-domain reference point and a reconstructed attribute value of the spatial-domain reference point; and
the determining the predicted attribute value of the current point based on the time-domain reference attribute value of the time-domain reference point and the reconstructed attribute value of the spatial-domain reference point comprises:
determining the predicted attribute value of the current point based on a weighted average value of the time-domain reference attribute value of the time-domain reference point and the reconstructed attribute value of the spatial-domain reference point.

16. The method according to claim 15, wherein before the determining the predicted attribute value of the current point based on the time-domain reference attribute value of the time-domain reference point and the reconstructed attribute value of the spatial-domain reference point, the method further comprises:
updating a reconstructed attribute value of a point in the at least one first refinement level based on an attribute residual value of a point in the current refinement level.

17. The method according to claim 16, wherein the updating the reconstructed attribute value of the point in the at least one first refinement level based on the attribute residual value of the point in the current refinement level comprises:
performing a second process based on an i^{th} point in the current refinement level, wherein the second process comprises:
determining one or more second nearest neighboring points of the i^{th} point in the current refinement level from the at least one first refinement level and the at least one second refinement level in the LOD of the reference point cloud, wherein i is greater than 0 and less than or equal to a total quantity of points in the current refinement level;
updating, based on an attribute residual value of the i^{th} point, a reconstructed attribute value of a point belonging to the first refinement level among the one or more second nearest neighboring points; and
iterating the second process based on an (i+1)^{th} point in the current refinement level, until the second process is performed based on the last point in the current refinement level.

18. The method according to claim 17, wherein the at least one first refinement level comprises a refinement level generated based on a maximum distance in the LOD of the current point cloud, and an initial reconstructed attribute value of a point in the refinement level generated based on the maximum distance is equal to a first value.

19. An encoding method, wherein the method is applied to a point cloud encoder, and the method comprises:
determining, based on geometric information of a current point cloud, a reference point of a current point in the current point cloud, wherein the reference point comprises a time-domain reference point, the time-domain reference point is one or more points in a reference point cloud, and the reference point cloud is point cloud data that has been encoded before encoding the current point cloud;
obtaining a weighted prediction parameter, wherein the weighted prediction parameter is determined based on attribute values of at least part of points in the current point cloud and reconstructed attribute values of at least part of points in the reference point cloud;
processing an attribute value of the time-domain reference point based on the weighted prediction parameter, to obtain a time-domain reference attribute value; and
determining an attribute residual value of the current point based on the time-domain reference attribute value of the time-domain reference point.

20. A non-transitory computer-readable storage medium, having a computer program and a bitstream stored thereon, wherein the computer program, when executed by a processor, enables the processor to perform the steps of the encoding method of claim 19 to generate the bitstream.
